(19) United States
(12) Patent Application Publication
(10) Pub. No.: US 2026/0110903 A1
(43) Pub. Date: Apr. 23, 2026

(54) Light Control Device

(71) Applicant: Envisics Ltd, Milton Keynes (GB)

(72) Inventors: Andrew Ramsbottom, Milton Keynes (GB); Timothy Smeeton, Milton Keynes (GB); Hugo Malin-Clegg, Milton Keynes (GB); Edward Boardman, Milton Keynes (GB)

(21) Appl. No.: 19/352,358

(22) Filed: Oct. 7, 2025

(30) Foreign Application Priority Data
Oct. 18, 2024 (GB) 2415322.3
Oct. 18, 2024 (GB) 2415330.6

(51) Int. Cl. G02B 27/01

(52) U.S. Cl. CPC G02B 27/0103; G02B 2027/0109; G02B 2027/0116

(57) ABSTRACT

Disclosed embodiments include a replicator arranged to receive spatially modulated light and replicate the spatially modulated light to form a plurality of replicas of the spatially modulated light by waveguiding between a reflective surface and a transmissive-reflective surface. The transmissive-reflective surface forms an output surface for the plurality of replicas of the spatially modulated light. Some embodiments additionally include a light control device (i) located in an optical path of the plurality of replicas of the spatially modulated light downstream from the output surface of the replicator, and (ii) arranged to provide a first angular turn to the replicas of the spatially modulated light. The first angular turn is caused by refractive power and has a primary component on a plane. Some embodiments also include a diffractive optical element arranged to provide a second angular turn to the spatially modulated light or the replicas thereof.

### CROSS-REFERENCE TO RELATED APPLICATIONS

This application claims priority under 35 U.S.C. § 119 to (i) UK Patent Application GB 2415322.3 titled “Light Control Device,” filed on Oct. 18, 2024, and currently pending and (ii) UK Patent Application GB 2415330.6 titled “Light Control Device,” filed on Oct. 18, 2024, and currently pending. The entire contents of GB 2415322.3 and GB 2415330.6 are incorporated by reference herein for all purposes.

### FIELD

The present disclosure relates to a light control layer (for example, a curvature corrective optic, windscreen corrective optic or a curvature-corrective, glare-mitigation device), a diffractive optical element, a reflection suppression device and a glare mitigation device. The present disclosure also relates to a display system comprising the light control layer and the diffractive optical element. The present disclosure further relates to methods of processing display light using the light control layer and the diffractive optical element. Some embodiments relate to a holographic projector, picture generating unit or head-up display.

### INTRODUCTION

Light scattered from an object contains both amplitude and phase information. This amplitude and phase information can be captured on, for example, a photosensitive plate by well-known interference techniques to form a holographic recording, or “hologram”, comprising interference fringes. The hologram may be reconstructed by illumination with suitable light to form a two-dimensional or three-dimensional holographic reconstruction, or replay image, representative of the original object.

Computer-generated holography may numerically simulate the interference process. A computer-generated hologram may be calculated by a technique based on a mathematical transformation such as a Fresnel or Fourier transform. These types of holograms may be referred to as Fresnel/Fourier transform holograms or simply Fresnel/Fourier holograms. A Fourier hologram may be considered a Fourier domain/plane representation of the object or a frequency domain/plane representation of the object. A computer-generated hologram may also be calculated by coherent ray tracing or a point cloud technique, for example.

A computer-generated hologram may be encoded on a spatial light modulator arranged to modulate the amplitude and/or phase of incident light. Light modulation may be achieved using electrically-addressable liquid crystals, optically-addressable liquid crystals or micro-mirrors, for example.

A spatial light modulator typically comprises a plurality of individually-addressable pixels which may also be referred to as cells or elements. The light modulation scheme may be binary, multilevel or continuous. Alternatively, the device may be continuous (i.e. is not comprised of pixels) and light modulation may therefore be continuous across the device. The spatial light modulator may be reflective meaning that modulated light is output in reflection. The spatial light modulator may equally be transmissive meaning that modulated light is output in transmission.

A holographic projector may be provided using the system described herein. Such projectors have found application in head-up displays, “HUD”.

### SUMMARY

Aspects of the present disclosure are defined in the appended independent claims.

In general terms, there is provided a light control device (optionally also providing glare mitigation) for display light that is arranged to compensate for the curvature of a curved optical component on an optical path of the display light. In embodiments, the light control device (optionally, glare mitigation device) is for display light of a display system. In some embodiments, the curved optical component is an optical combiner, such as a vehicle windscreen, arranged to redirect display light from a display device to a viewing window or so-called eye-box. The optical component may have a first curvature in a first direction and a second curvature in a second direction perpendicular to the first direction. The first and/or second curvature may be non-linear. The optical component has a complex curvature which introduces complex distortions when used in a display system particularly one based on holographic projection.

The display light may be spatially modulated light. The display system may be arranged to relay the spatially modulated light to a viewing plane or eye-box. In some embodiments, the display system is a holographic display system and the spatially modulated light is light that is spatially modulated in accordance with a hologram (of a picture or image). The spatially modulated light may be referred to as a holographic wavefront. In another embodiment, the display system is a picture generating unit and the spatially modulated light is light that is spatially modulated in accordance with a picture (in other words, an image). The spatially modulated light, in these embodiments, may be referred to as a picture wavefront (or an image wavefront). The light control device of the present disclosure may optionally provide a means for controlling reflections of ambient light to prevent or suppress glare from reaching the viewing plane while allowing the spatially modulated light to reach the viewing plane. For example, the display device may comprise an optical component comprising a reflective surface such as a substantially planar (e.g. glass) waveguide. In the absence of the light control device, ambient light may be reflected by the reflective surface towards the viewing plane/eye-box of the display device thus forming glare. The light control device of the present disclosure may be arranged to suppress such reflections.

As above, the light control device of the present disclosure is primarily arranged to compensate for the curvature of a curved optical component on an optical path of the display system. A secondary purpose is to provide a (non-zero) optical “turn” of the display light. A tertiary purpose may be reflection suppression, such as glare mitigation. The curved optical component being on the optical path of the display system may mean that the spatially modulated light, propagating through the display system, may be incident on, reflected by, transmitted through, or otherwise interact with a curved optical component, such as a combiner or windscreen. As the skilled person will appreciate, the curvature of the optical component may alter the divergence or convergence of the spatially modulated light and angles thereof. For example, if the spatially modulated light is substantially collimated upstream of the curved optical component (prior to interacting with the optical component), then the spatially modulated may be non-parallel (e.g. converging or diverging) downstream of the curved optical component (after interacting with the optical component). In other words, the curved optical component may have a lensing effect on the spatially modulated light incident thereon. If the curvature of the curved optical component is non-uniform, then the lensing effect may be non-uniform. For example, different portions of the curved optical component may have a different (local) radius of curvature and so may have a different lensing effect on spatially modulated light incident thereon. In some embodiments, the curved optical component is a windscreen or windshield of a vehicle. A windscreen or windshield may have a complex curvature having a complex lensing effect on display light incident thereon.

The lensing effect of the curved optical combiner may distort the display light (of the display system). For example, the display light may be such that a picture is viewable from a viewing plane. For example, the display light may be spatially modulated in accordance with a hologram of a picture, or simply in accordance with a picture. The lensing effect of the curved optical component may distort the picture that is viewable at the viewing plane. This may adversely affect a viewing experience of the display system. Another problem identified by the inventors is specific to display systems comprising a replicator, upstream of the curved optical component. The replicator may be arranged to replicate the spatially modulated light to form a plurality of replicas of the spatially modulated light. In embodiments, the replicator may be a waveguide, as described below. For example, the waveguide may comprise an input port arranged to receive the spatially modulated light. The waveguide may comprise a pair of surfaces arranged to waveguide the spatially modulated light received at the input therebetween. A first surface of the pair of surfaces may be partially-transmissive partially-reflective. The first surface may be arranged to form the plurality of replicas of the spatially modulated light. At least a portion of the first surface may be said to form an output port of the replicator/waveguide. The replicator may be arranged such that the plurality of replicas are relayed towards the curved optical component. The display system may be further arranged such that the plurality of replicas is relayed towards a viewing plane/eye-box of the display system. The inventors have found that the pitch of the replicas of the spatially modulated light (at the viewing plane) is important for ensuring a good viewing experience. Through simulation and experimentation, the inventors have further found that the pitch of the replicas may be affected by the lensing effect of the curved optical component. For example, the pitch of the replicas at the viewing plane may be increased or decreased. This may adversely affect the viewing experience. For example, if the pitch of the replicas is reduced, so-called ghosting effects, in which a copy of the intended picture or image content is displayed slightly offset from the intended picture or image content, may become more apparent. The pitch of the replicas may be reduced if the curved optical component has a concave shape, for example the inside surface of a windscreen or windshield. As used herein, the pitch of replicas refers to the separation or distance between the centres of adjacent replicas.

The inventors have previously proposed light control devices/glare mitigation devices for reflection/glare suppression, as discussed for example in GB2607672B and GB2627988A.

In other words, in display systems (such as head-up display systems), the effective pupil of the display system (more specifically the image projecting system used to project to image to the user) is expanded. This expansion may be by means of a plurality (e.g. a pair) of waveguides that each expand the pupil in a different dimension. These waveguides multiply reflect light bundles, providing a “replication” of the pupil in two dimensions in order to fill an extended viewing window (in other words, an eye-box) many times greater in size than the pupil of the display system. For this to work effectively, the light received and subsequently transmitted by the waveguides may be collimated such that, for any single point in the light field, there is no variation in angle (and resultant projected image position) as the light is reflected within the waveguides. This light is then reflected off an optical component functioning as an optical combiner (such as a windscreen) to fill a virtual viewing window (an “eye-box”) at the user's/viewer's head position.

Due to the complex curvature of the optical component, as well as the relative angles between the display device, the surface of the optical component, the user's position and the user's line of sight, there is a need to optically adjust (e.g. “turn”) the light emerging from the final waveguide by means of a light control device (also referred to herein more specifically as a corrective optic). This corrective optic needs to simultaneously provide optical power, correct for the complex optical aberrations introduced by the non-uniform curvature of the optical component and its orientation relative to path of the display light, and, optionally, provide a “turning” function. The optical power provided must be complimentary to the optical power of the optical component, so they jointly project a virtual image at a specified viewing distance in front of the user. The turning function may ensure that the display light travels in a direction coincident with the user's line of sight (referred to as the optical axis). In other words, the turning function is in the azimuthal direction. The corrective optic may optionally also provide the glare mitigation function as described above.

The inventors have previously proposed light control devices provided as a Fresnel structure. Such a component has the advantage of being able to provide the required optical functions in a relatively flat, light-weight format. This has been disclosed, for example, in British patent application GB2401627.1. However, the present disclosure could also apply to non-Fresnel, conventional optical elements, or a combination of Fresnel and non-Fresnel elements performing the equivalent optical corrective function.

These light control devices are often single optical elements (i.e. a single component arranged to provide the above-described optical effects). A single optical element providing the above described refractive power may result in chromatic aberrations of the light passing therethrough, due to the chromatic dispersion (in other words, chromatic offset) of its constituent material (i.e. different wavelengths being refracted by different amounts, with shorter wavelengths being refracted more than longer wavelengths). In other optical systems, these aberrations are conventionally substantially corrected using combinations of optical elements with different optical powers (i.e. positive and negative) and material characteristics (i.e. refractive index and dispersion). These parameters are carefully chosen to provide the required chromatic correction and form part of achromatic or apochromatic optical designs. However, in a single, flat corrective element as typically used in the above-described display system, these design degrees of freedom do not exist (as multiple optical elements would take up more space, which is at a premium in applications such as in automotive vehicles). As such, there may be a wavelength variation in the performance of the light control device.

Typically, the main refractive power of the light control device is provided by a prismatic structure that provides an optical power causing a turn of the display light on a plane both parallel to the optical axis and orthogonal to the light control device. It may be said that the refractive power of the light control device or corrective optic comprises a first portion and a second portion (in other words, a first and second component). The first portion is refractive and substantially uniform in order to provide a (global) optical turn of the display light. The second portion is also refractive but substantially non-uniform and provides a spatially variant (across its output surface) correction for the curvature of the optical component. The first portion may be greater than the second portion. The first portion may be at least double or even ten, such as at least twenty, times greater than the second portion in magnitude. At least conceptually, it may therefore be said that a relatively small amount of the total refractive power of the light control device performs the correction for the curvature of the optical component. The main effect of the chromatic aberrations caused by the material's chromatic dispersion, as described above, will therefore be the offset of this angular “turning” deflection by different amounts according to wavelength (blue wavelengths greater than red wavelengths). The level of this offset may be relatively large compared to the resolution required of the display.

For a display system where the light replicated is generated from separate RGB sources (e.g. laser diodes), this chromatic aberration can be substantially mitigated by offsetting the originating image for each wavelength in such a way as to compensate for the offsets caused by the light control device. For a computer-generated holographic image, this offset might usefully be varied across the field of view as required. However, even with these mitigations there may still be a level of chromatic offset in the final projected image causing an unacceptable pixel-colour misalignment. This is due to the varying level of refractive and prismatic power across the aperture of the light control device, which is necessary to correct for the complex curvature of the optical component. This is fundamentally not possible to correct by varying the wavelength offsets according to field position in the generated originating image, since any single point in the image will be replicated over a large area of the light control device to provide the large eye box required. As such, there is no one-to-one correspondence between a point in the image and a position across the light control device. In simple terms, a more sophisticated solution to the problem of chromatic aberration, caused by using a refractive component for multicolour display, is required.

In a first aspect, a display system is provided. The display system may be described as having a viewing window (in other words, an eye-box). The viewing window is a virtual/imaginary space within which a user can observe the image(s) to be displayed to a sufficiently high quality and/or with sufficiently few optical distortions/anomalies (as determined by the designer of the display system in question). The display system comprises a replicator. The replicator may be a waveguide, specifically in this case the replicator may be the final waveguide (of a pair of waveguides) in the path of the light through the display system. The replicator is arranged to receive spatially modulated light and replicate the spatially modulated light to form a plurality of replicas of the spatially modulated light by waveguiding between a reflective surface and a transmissive-reflective surface. As described above, the replicator may be the final replicator in the path of the light through the display system and therefore may replicate a one-dimension line of replicas to form a two-dimensional array of replicas. The transmissive-reflective surface forms an output surface for the plurality of replicas of the spatially modulated light. The display system further comprises a light control device located in the optical path of the plurality of replicas of the spatially modulated light downstream from the output surface of the replicator. As discussed above, the light control device may also be referred to as a corrective device/optic or a corrective glare mitigation device/optic and may optionally perform both the glare mitigation and optical component curvature compensation functions as described above. The light control device is arranged to provide (in other words, apply) a first angular turn to the replicas of the spatially modulated light (or a portion thereof). That is, light is received by the light control device at a first angle and is emitted therefrom at a second, different, angle. The first angular turn (which may also be described as a first angular turning function) is caused by refractive power (of the light control device). That is, the first angular turn is caused by refraction (of the light passing therethrough). The first angular turn has a primary component on a plane. The plane may be described as being perpendicular/orthogonal to the output surface of the replicator. Notably, the display system further comprises a diffractive optical element. The diffractive optical element is arranged to provide (in other words, apply) a second angular turn to the spatially modulated light or the replicas thereof. As will be discussed in greater detail below, whether the second angular turn is provided to the spatially modulated light or the replicas thereof depends on the location of the diffractive optical element within the display system. As with the first angular turn as described above, light is received by the diffractive optical element at a first angle and is emitted therefrom at a second, different, angle. Notably, the second angular turn (which may also be described as a second angular turning function) is caused by diffractive power (of the diffractive optical element). That is, the second angular turn is caused by diffraction (of the light passing therethrough). The second angular turn has a primary component on the plane (i.e. the same plane as described above in relation to the first angular turn). A chromatic dispersion of the first angular turn caused by the refractive power of the light control device is substantially compensated by a chromatic dispersion of the second angular turn caused by the diffractive power of the diffractive optical element. In other words, the chromatic dispersion of the first angular turn caused by the refractive power of the light control device is sufficiently equal and opposite to the chromatic dispersion of the second angular turn caused by the diffractive power of the diffractive optical element. By the chromatic dispersion of the angular turns it is meant that each wavelength of light is turned by a different amount, and so the turn provided at each wavelength by the diffractive optical element is arranged to compensate for the turn of light in that wavelength by the light control device. The term “sufficient” or “substantially” in this case means that the chromatic dispersion is compensated such that the net chromatic dispersion across the system is reduced and/or is below a threshold such as within the acceptable limits determined by the designer of the display system (e.g. no visible by the user). In other words, the chromatic dispersions of the light control device and diffractive optical element are arranged such that, for replicas of two different wavelengths that are emitted from the replicator in a substantially parallel direction, these replicas are emitted from the display system in a substantially parallel direction. It may be said that a magnitude of the refractive power and a magnitude of the diffractive power are such that the compensation occurs. The turn and chromatic dispersion thereof is described as being in one direction (i.e. on a single plane), however the system may also substantially compensate for chromatic dispersion of angular turns in other planes orthogonal to the output surface of the replicator. That is, the “primary component” described herein is the turn in one direction, but turn may also have a secondary component in a different direction (i.e. on a different plane parallel to the plane described above).

In this way, the presence or occurrence of chromatic aberrations can be reduced, thereby reducing the colour misalignment of the pixels of the displayed image. Using the diffractive optical element, and more specifically its diffractive power, the chromatic dispersion caused by the light control device can be counteracted. That is, the change in wavelength of parts of the light is compensated for by the diffractive optical element.

In other words, the light control device and the diffractive optical element together are designed such that the required turning function is provided by the combination of the light control device and the diffractive optical element. The diffractive optical elements is fundamentally strongly wavelength dispersive, compared to refractive elements of a similar optical power, as will be discussed further below. However, this dispersion is in the opposite direction to the wavelength dispersion of refractive materials such as the light control device, with longer wavelengths diffracted more the shorter wavelengths (i.e. red light more than blue light). By choosing the turning power of the light control device and diffractive optical element appropriately (i.e. such the overall turning function is distributed between the two components), it is possible to provide a required total level of turning function, whilst eliminating the total net chromatic dispersion for any two wavelengths.

The inventors recognised that it was necessary to find a solution that could substantially compensate for chromatic dispersion whilst retaining a net optical “turn”. Notably, the inventors realised that this could be achieved by using a component that had a dispersion with a different dependency on wavelength such that it could be combined with the refractive component without entirely cancelling out the required optical “turn”. The inventors turned to diffraction and realised that a combination of a refractive component and a diffractive component could be arranged to cancel out each other's chromatic dispersion whilst retaining a net optical “turn”.

The chromatic dispersion may be a first chromatic dispersion in a first wavelength. A second chromatic dispersion of the first angular turn in a second wavelength caused by the refractive power of the light control device may be substantially compensated by the chromatic dispersion of the second angular turn caused by the diffractive power of the diffractive optical element. The first wavelength may correspond to a red wavelength and the second wavelength may correspond to a blue wavelength.

Since the variation in dispersion with wavelength has a non-linear characteristic, said characteristic being different for refractive components (i.e. the light control device) as compared to diffractive components (i.e. the diffractive optical element), the compensation/correction can only be exact for a two particular pairs of wavelengths. For example, if the correction is for red and blue light, there will still be some dispersion between the red/blue light relative to any green light. However, the inventors have surprisingly found that level of dispersion between the red/blue light relative to the green light will be significantly reduced compared to if no correction/compensation were to be applied. Therefore, the arrangement of a refractive component and diffractive component, as described herein, at least reduces chromatic dispersion.

The first angular turn and second angular turn may result in a non-zero net angular turn on the plane. That is, whilst the chromatic dispersion is (at least partially) compensated, that does not remove the overall turning function (i.e. the one that would have been provided by the light control device without the presence of the diffractive optical element). This turn is used to direct the replicas to the (eye-box/viewing window of the) user.

The magnitude of first angular turn may be at least ten times that of second angular turn. In other words, the magnitude of first angular turn may be an order of magnitude larger than that of second angular turn. For equivalent levels of turning function, diffractive components (such as the diffractive optical element) can be many times more dispersive than refractive materials (such as the light control device), typically by a factor of ten to twenty. Therefore, this requires the diffractive optical element to be an order of magnitude less than that required of the light control device, in order to provide the required dispersion compensation. For example, if the total turning power required is fifteen degrees, then this may be distributed in the ratio of fourteen degrees provided by the light control device and one degree provided by the diffractive optical element. These embodiments are advantageous because diffraction can introduce image artefacts. More specifically, these embodiments provide a good balance of using diffraction to counteract the chromatic dispersion of the refractive component (whilst retaining a net “turn”), without strongly risking diffraction artefacts that spoil the viewing experience.

The refractive power of the light control device may be non-uniform and the diffractive power of the diffractive optical element may be uniform. Alternatively, the refractive power of both the light control device and the diffractive power of the diffractive optical element may be non-uniform. That is, the light control device is often non-uniform in its refractive power, as each point across the light control device is designed to deal with the varying and complex curvature of an optical component, as described above. The diffractive optical element may be uniform, thereby providing a less accurate compensation across the surface of the light control device, but being easier and cheaper to design and manufacture. The diffractive optical element may alternatively be non-uniform, with each point designed to compensate for the corresponding point of the light control device, as will be discussed further below. This increases the complexity (and therefore cost) of the component, but makes the compensation more accurate.

The diffractive optical element may be located downstream of the light control device (and thus may be arranged to provide the second angular turn to the spatially modulated light received by the replicator). Alternatively, the diffractive optical element may be located downstream of the replicator and upstream of the light control device (and thus may be arranged to provide the second angular turn to the spatially modulated light received by the replicator). That is, the diffractive optical element may be located before or after the light control device on the optical path of the light through the display system to the user (or the eye-box/viewing window).

Alternatively, the diffractive optical element may be located upstream of the replicator (and thus may be arranged to provide the second angular turn to the replicas of the spatially modulated light). That is, the diffractive optical element may be located before the replicator on the optical path of the light through the display system to the user (or the eye-box/viewing window). In other words, a diffractive optical element may be provided that provides diffractive power to the one-dimensional array of replicas before they are received by the replicator to form the two-dimensional array. As such, the diffractive optical element in this case may be smaller (i.e. thinner), as it only has to receive a one-dimensional array, rather than the two dimensional array from the replicator or light control device. The inventors have surprisingly found that this is possible as the direction of the required optical dispersion correction is almost entirely in the azimuthal direction (i.e. parallel to the output surface of the replicator), and so the diffractive optical element only needs to provide diffractive power in the plane of the output surface.

In this case, there is no longer an exact one-to-one correspondence between points on the diffractive optical element and the light control device—that is, each point on the diffractive optical element potentially serves a range of points on the replicator corresponding to a range of field points emitted from the light control device. The inventors have found, however, that depending on how the field-of-view is designed (e.g. the eye-box/viewing window size and its geometrical separation relative to the rest of the display system), there may still be a high level of correlation between the optical dispersion compensation required at any point along the length of the light control device parallel to the diffractive optical element and a corresponding position on the diffractive optical element where the correction could be implemented. As such, an advantageous level of net optical dispersion correction is still possible, with the advantage in this scenario of a reduced size and cost of diffractive optical element.

The refractive power of the light control device and the diffractive power of the diffractive optical element may be functions of the position on the output surface. In other words, the refractive power of the light control device and the diffractive power of the diffractive optical element may be dependent on the position on the output surface. As discussed above, this allows the turn applied to the replicas to be varied to compensate for the varying and complex curvature of an optical component.

The light control device may be a Fresnel structure (e.g. comprise Fresnel-type prisms), may be part of a Fresnel lens or may be a Fresnel lens. As discussed above, these structures and lenses are relatively small (i.e. compact) and lightweight, ideal for applications such as those in the automotive, in which space and weight are at a premium.

The display system may further comprise a curved optical component downstream from the light control device. The light control device may have an opposite lensing effect of the curved optical element. The curved optical component may be an optical combiner, such as a windscreen of a vehicle. The light control device may be arranged to compensate for the curvature of the curved optical component. The compensation may be a function of the position on the output surface. The compensation may have negative optical power. The compensation may be a phase function, optionally a phase-delay function.

The diffractive optical element may be a linear grating and/or a blazed grating comprising a plurality (in other words, a series or regular array) of gratings. The diffractive optical element may be a linear blazed grating and the gratings may extend along a first direction. The gratings may have a grating pitch that varies along a second direction, the second direction being perpendicular to the first direction. That is, the spacing between the gratings may vary as required to vary the turn applied to the spatially modulated light or the replicas thereof as described above.

Each grating may have a facet arranged a surface angle relative to a plane of the diffractive optical element, each surface angle being chosen such that the associated refraction substantially matches the diffraction angle of an order of refraction. In other words, the surface angle of each grating facet may be tilted with respect to the plane that the diffractive optical element extends on/across.

The inventors have found that there can be a need to ensure high diffraction efficiency in a single order of the diffractive optical component, in order to reduce the presence of ghosts in the displayed image (which can be the result of multiple orders of diffraction reaching the eye-box/viewing window). Said efficiency can be increased by tilting the surface angle of the grating facet (blazing) to a specific angle, such that the refraction angle associated with that surface matches the diffraction angle of the required order (which may be the first order). This can result in up to 100% efficiency in the first order, however only in a single wavelength. For example, if the surface angle is chosen to optimise the green wavelength, there may be slight reduction in efficiency in the first order and some diffraction into other orders for the corresponding red and blue light. However, the inventors have surprisingly found that there are still efficiency gains across all wavelengths of light.

The diffractive optical element may manufactured from a reactive mesogen material patterned to impart a phase-delay function. This may be described as being by means of the Pancharatnam-Berry effect, as is discussed further below.

The spatially modulated light may be a holographic wavefront and the replicator may be arranged to form a plurality of replicas of the holographic wavefront. The light may be spatially modulated in accordance with a picture. The light may be spatially modulated in accordance with a hologram of a picture. The hologram may be arranged to divide the spatial content of the picture by angle such that angles of the spatially modulated light correspond to spatial coordinates of the picture. The display system may further comprise a numerical aperture expander, such as a diffuser, arranged to increase a numerical aperture of the spatially modulated light received by the replicator. In other words, the display system may a “hologram-to-eye”-type system in which the eye (or other such viewing system) reconstructs the image or a system in which an image arrives at the eye. That is, the display system may project light in the image or hologram domain.

In a second aspect, a method of display is provided. The method comprises receiving spatially modulated light at a replicator. The method further comprises replicating the spatially modulated light via (or using) the replicator to form a plurality of replicas of the spatially modulated light by waveguiding between a reflective surface and a transmissive-reflective surface. The transmissive-reflective surface forms an output surface for the plurality of replicas of the spatially modulated light. The method further comprises providing a first angular turn to the replicas of the spatially modulated light via (or using) a light control device located in the optical path of the plurality of replicas of the spatially modulated light downstream from the output surface of the replicator. The first angular turn is caused by refractive power and has a primary component on a plane. The plane may be described as being perpendicular/orthogonal to the output surface of the replicator. The method further comprises providing a second angular turn to the spatially modulated light or the replicas thereof via a diffractive optical element. The order (i.e. the location) of this step in the method depends on where the diffractive optical element is located within the display system carrying out the method, as discussed above. The second angular turn is caused by diffractive power and has a primary component on the plane (i.e. the same plane as the first angular turn). The method further comprises substantially compensating a chromatic dispersion of the first angular turn caused by the refractive power of the light control device by a chromatic dispersion of the second angular turn caused by the diffractive power of the diffractive optical element.

In a third aspect, a display system is provided. The display system comprises a replicator. The replicator is arranged to receive spatially modulated light and replicate the spatially modulated light to form a plurality of replicas of the spatially modulated light by waveguiding between a reflective surface and a transmissive-reflective surface. The transmissive-reflective surface forms an output surface for the plurality of replicas of the spatially modulated light. The display system further comprises a light control device located in the optical path of the plurality of replicas of the spatially modulated light downstream from the output surface of the replicator. The light control device is arranged to provide (in other words, apply) a first angular turn to the replicas of the spatially modulated light (or a portion thereof). The first angular turn (which may also be described as a first angular turning function) is caused by refractive power (of the light control device). The first angular turn has a primary component on a plane. The display system further comprises a reactive mesogen optical element. The reactive mesogen optical element is arranged to provide (in other words, apply) a second angular turn to the spatially modulated light or the replicas thereof. As with regards to the first aspect, whether the second angular turn is provided to the spatially modulated light or the replicas thereof depends on the location of the reactive mesogen optical element within the display system. The second angular turn (which may also be described as a second angular turning function) is caused by diffractive power (of the reactive mesogen optical element). The second angular turn has a primary component on the plane (i.e. the same plane as the first angular turn). A chromatic dispersion of the first angular turn caused by the refractive power of the light control device is substantially compensated by a chromatic dispersion of the second angular turn caused by the diffractive power of the reactive mesogen optical element.

In this way, using a reactive mesogen optical element can avoid the loss of diffraction efficiency into the first order at wavelengths other than the nominal design wavelength. In other words, the diffraction efficiency is no longer tied to wavelength and so can be optimised across the full light spectrum as required. Compared to the linear, blazed gratings, a linear varying phase retardation (and therefore turn) can be provided that is linear regardless of the wavelength of the light.

The reactive mesogen optical element may be patterned to impart a phase-delay function by means of the Pancharatnam-Berry effect. The function may be a spatially varying geometric phase-delay function. The function may be linear. The function may be in accordance with the formula Δφ/Δx=2·(π/d), wherein Δx is the differential path length across which the phase-delay is to be determined, Δφ is the change in phase-delay over the path length and d is the grating period of an equivalent linear, blazed diffractive optical element.

The direction of refraction of the reactive mesogen material is normal to the wavefront emerging from the material and so is determined such that the differential path length across a section of the wavefront (Δx sin θ), with associated phase difference (2π/λ)·Δx sin θ, is equivalent to the phase retardation imparted by the reactive mesogen material across the same differential path length (Δφ), hence:

$$( 2 \cdot π / λ ) \cdot Δ x \cdot sin θ = Δ ϕ$$

Comparing this with the diffraction equation, which determines the direction of diffracted light into the first order, for a grating of period d:

$$d \cdot sin θ = λ$$

We see that there is a dependence of the diffraction (i.e. the turning) angle (e) on the wavelength A, and that this dependence has the same form in each case. As such, the inventors have surprisingly found that, providing the linear varying retardance of the reactive mesogen material is chosen appropriately, such that: Δφ/(Δx=(2·π)/d), then the angle of refraction from reactive mesogen material will be equal to that of the diffraction angle from an equivalent diffraction grating.

Such a reactive mesogen optical element will therefore serve to correct the dispersion of the light control device in the same way as a linear (blazed) grating, with nominally 100% efficiency into the diffracted 1st order for all wavelengths.

The reactive mesogen optical element may be sandwiched between a pair of quarter-wave plates.

In a fourth aspect, a method of display is provided. The method comprises receiving spatially modulated light at a replicator. The method further comprises replicating the spatially modulated light via the replicator to form a plurality of replicas of the spatially modulated light by waveguiding between a reflective surface and a transmissive-reflective surface. The transmissive-reflective surface forms an output surface for the plurality of replicas of the spatially modulated light. The method further comprises providing a first angular turn to the replicas of the spatially modulated light via a light control device located in the optical path of the plurality of replicas of the spatially modulated light downstream from the output surface of the replicator. The first angular turn is caused by refractive power and has a primary component on a plane. The method further comprises providing a second angular turn to the spatially modulated light or the replicas thereof via a reactive mesogen optical element. The location of this step in the method depends on where the reactive mesogen optical element is located within the display system carrying out the method, as discussed above. The second angular turn is caused by diffractive power and has a primary component on the plane (i.e. the same plane as the first angular turn). The method further comprises substantially compensating a chromatic dispersion of the first angular turn caused by the refractive power of the light control device by a chromatic dispersion of the second angular turn caused by the diffractive power of the reactive mesogen optical element.

In a fifth aspect, a method of manufacturing a reactive mesogen optical element for use in a display system is provided. The reactive mesogen optical element comprises at least one section having a differential path length Δx. The method comprises patterning each section to impart a phase-delay according to the function Δφ/Δx=2·(π/d). Δφ is the phase-delay required across the differential path length Δx of each section and d is the grating period required for each section of an equivalent linear diffractive grating.

Features and advantages described in relation to the first aspect may apply to the methods of the second, fourth and fifth aspects and the system of the third aspect, and vice versa.

In the present disclosure, the term “replica” is merely used to reflect that spatially modulated light is divided such that a complex light field is directed along a plurality of different optical paths. The word “replica” is used to refer to each occurrence or instance of the complex light field after a replication event—such as a partial reflection-transmission by a pupil expander. Each replica travels along a different optical path. Some embodiments of the present disclosure relate to propagation of light that is encoded with a hologram, not an image—i.e., light that is spatially modulated with a hologram of an image, not the image itself. It may therefore be said that a plurality of replicas of the hologram are formed. The person skilled in the art of holography will appreciate that the complex light field associated with propagation of light encoded with a hologram will change with propagation distance. Use herein of the term “replica” is independent of propagation distance and so the two branches or paths of light associated with a replication event are still referred to as “replicas” of each other even if the branches are a different length, such that the complex light field has evolved differently along each path. That is, two complex light fields are still considered “replicas” in accordance with this disclosure even if they are associated with different propagation distances-providing they have arisen from the same replication event or series of replication events.

A “diffracted light field” or “diffractive light field” in accordance with this disclosure is a light field formed by diffraction. A diffracted light field may be formed by illuminating a corresponding diffractive pattern. In accordance with this disclosure, an example of a diffractive pattern is a hologram and an example of a diffracted light field is a holographic light field or a light field forming a holographic reconstruction of an image. The holographic light field forms a (holographic) reconstruction of an image on a replay plane. The holographic light field that propagates from the hologram to the replay plane may be said to comprise light encoded with the hologram or light in the hologram domain. A diffracted light field is characterized by a diffraction angle determined by the smallest feature size of the diffractive structure and the wavelength of the light (of the diffracted light field). In accordance with this disclosure, it may also be said that a “diffracted light field” is a light field that forms a reconstruction on a plane spatially separated from the corresponding diffractive structure. An optical system is disclosed herein for propagating a diffracted light field from a diffractive structure to a viewer. The diffracted light field may form an image.

The term “hologram” is used to refer to the recording which contains amplitude information or phase information, or some combination thereof, regarding the object. The term “holographic reconstruction” is used to refer to the optical reconstruction of the object which is formed by illuminating the hologram. The system disclosed herein is described as a “holographic projector” because the holographic reconstruction is a real image and spatially-separated from the hologram. The term “replay field” is used to refer to the 2D area within which the holographic reconstruction is formed and fully focused. If the hologram is displayed on a spatial light modulator comprising pixels, the replay field will be repeated in the form of a plurality diffracted orders wherein each diffracted order is a replica of the zeroth-order replay field. The zeroth-order replay field generally corresponds to the preferred or primary replay field because it is the brightest replay field. Unless explicitly stated otherwise, the term “replay field” should be taken as referring to the zeroth-order replay field. The term “replay plane” is used to refer to the plane in space containing all the replay fields. The terms “image”, “replay image” and “image region” refer to areas of the replay field illuminated by light of the holographic reconstruction. In some embodiments, the “image” may comprise discrete spots which may be referred to as “image spots” or, for convenience only, “image pixels”.

The terms “encoding”, “writing” or “addressing” are used to describe the process of providing the plurality of pixels of the SLM with a respective plurality of control values which respectively determine the modulation level of each pixel. It may be said that the pixels of the SLM are configured to “display” a light modulation distribution in response to receiving the plurality of control values. Thus, the SLM may be said to “display” a hologram and the hologram may be considered an array of light modulation values or levels.

It has been found that a holographic reconstruction of acceptable quality can be formed from a “hologram” containing only phase information related to the Fourier transform of the original object. Such a holographic recording may be referred to as a phase-only hologram. Embodiments relate to a phase-only hologram but the present disclosure is equally applicable to amplitude-only holography.

The present disclosure is also equally applicable to forming a holographic reconstruction using amplitude and phase information related to the Fourier transform of the original object. In some embodiments, this is achieved by complex modulation using a so-called fully complex hologram which contains both amplitude and phase information related to the original object. Such a hologram may be referred to as a fully-complex hologram because the value (grey level) assigned to each pixel of the hologram has an amplitude and phase component. The value (grey level) assigned to each pixel may be represented as a complex number having both amplitude and phase components. In some embodiments, a fully-complex computer-generated hologram is calculated.

Reference may be made to the phase value, phase component, phase information or, simply, phase of pixels of the computer-generated hologram or the spatial light modulator as shorthand for “phase-delay”. That is, any phase value described is, in fact, a number (e.g. in the range 0 to 2π) which represents the amount of phase retardation provided by that pixel. For example, a pixel of the spatial light modulator described as having a phase value of π/2 will retard the phase of received light by π/2 radians. In some embodiments, each pixel of the spatial light modulator is operable in one of a plurality of possible modulation values (e.g. phase delay values). The term “grey level” may be used to refer to the plurality of available modulation levels. For example, the term “grey level” may be used for convenience to refer to the plurality of available phase levels in a phase-only modulator even though different phase levels do not provide different shades of grey. The term “grey level” may also be used for convenience to refer to the plurality of available complex modulation levels in a complex modulator.

The hologram therefore comprises an array of grey levels—that is, an array of light modulation values such as an array of phase-delay values or complex modulation values. The hologram is also considered a diffractive pattern because it is a pattern that causes diffraction when displayed on a spatial light modulator and illuminated with light having a wavelength comparable to, generally less than, the pixel pitch of the spatial light modulator. Reference is made herein to combining the hologram with other diffractive patterns such as diffractive patterns functioning as a lens or grating. For example, a diffractive pattern functioning as a grating may be combined with a hologram to translate the replay field on the replay plane or a diffractive pattern functioning as a lens may be combined with a hologram to focus the holographic reconstruction on a replay plane in the near field.

Although different embodiments and groups of embodiments may be disclosed separately in the detailed description which follows, any feature of any embodiment or group of embodiments may be combined with any other feature or combination of features of any embodiment or group of embodiments. That is, all possible combinations and permutations of features disclosed in the present disclosure are envisaged.

### BRIEF DESCRIPTION OF THE DRAWINGS

Specific embodiments are described by way of example only with reference to the following figures:

FIG. 1 is a schematic showing a reflective SLM producing a holographic reconstruction on a screen;

FIG. 2 shows an image for projection comprising eight image areas/components, V1 to V8, and cross-sections of the corresponding hologram channels, H1-H8;

FIG. 3 shows a hologram displayed on an LCOS that directs light into a plurality of discrete areas;

FIG. 4 shows a system, including a display device that displays a hologram that has been calculated as illustrated in FIGS. 2 and 3;

FIG. 5A shows a perspective view of a first example two-dimensional pupil expander comprising two replicators each comprising pairs of stacked surfaces;

FIG. 5B shows a perspective view of a first example two-dimensional pupil expander comprising two replicators each in the form of a solid waveguide;

FIG. 6 is a schematic side view of a display system according to a first embodiment of the present disclosure;

FIG. 7 is a schematic side view of a corrective glare mitigation device in combination with a diffractive optical element;

FIG. 8 is a schematic side view of a display system according to a second embodiment of the present disclosure;

FIG. 9 is a schematic side view of a display system according to a third embodiment of the present disclosure; and

FIG. 10 is a schematic side view of a diffractive optical element according to a fourth embodiment of the present disclosure.

The same reference numbers will be used throughout the drawings to refer to the same or like parts.

### DETAILED DESCRIPTION OF EMBODIMENTS

The present invention is not restricted to the embodiments described in the following but extends to the full scope of the appended claims. That is, the present invention may be embodied in different forms and should not be construed as limited to the described embodiments, which are set out for the purpose of illustration.

Terms of a singular form may include plural forms unless specified otherwise.

A structure described as being formed at an upper portion/lower portion of another structure or on/under the other structure should be construed as including a case where the structures contact each other and, moreover, a case where a third structure is disposed there between.

In describing a time relationship—for example, when the temporal order of events is described as “after”, “subsequent”, “next”, “before” or suchlike—the present disclosure should be taken to include continuous and non-continuous events unless otherwise specified. For example, the description should be taken to include a case which is not continuous unless wording such as “just”, “immediate” or “direct” is used.

Although the terms “first”, “second”, etc. may be used herein to describe various elements, these elements are not to be limited by these terms. These terms are only used to distinguish one element from another. For example, a first element could be termed a second element, and, similarly, a second element could be termed a first element, without departing from the scope of the appended claims.

Features of different embodiments may be partially or overall coupled to or combined with each other, and may be variously inter-operated with each other. Some embodiments may be carried out independently from each other, or may be carried out together in co-dependent relationship.

In the present disclosure, the term “substantially” when applied to a structural units of an apparatus may be interpreted as the technical feature of the structural units being produced within the technical tolerance of the method used to manufacture it.

### Conventional Optical Configuration for Holographic Projection

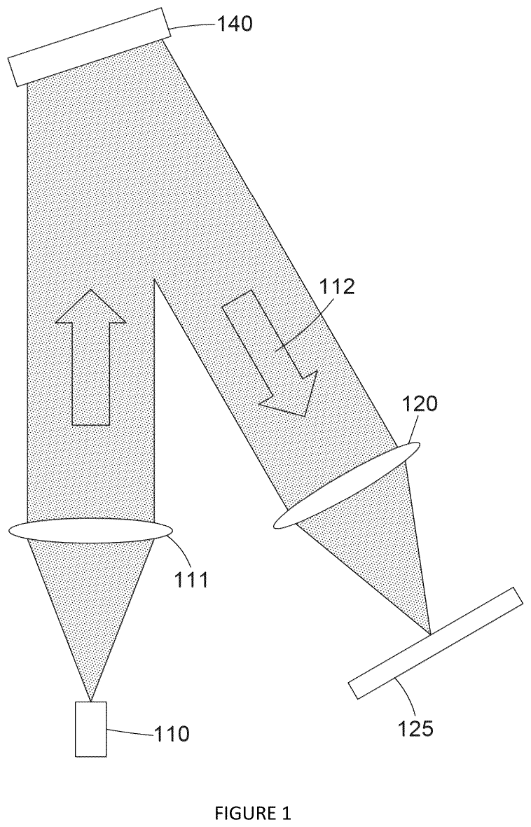

FIG. 1 shows an embodiment in which a computer-generated hologram is encoded on a single spatial light modulator. The computer-generated hologram is a Fourier transform of the object for reconstruction. It may therefore be said that the hologram is a Fourier domain or frequency domain or spectral domain representation of the object. In this embodiment, the spatial light modulator is a reflective liquid crystal on silicon, “LCOS”, device. The hologram is encoded on the spatial light modulator and a holographic reconstruction is formed at a replay field, for example, a light receiving surface such as a screen or diffuser.

A light source 110, for example a laser or laser diode, is disposed to illuminate the SLM 140 via a collimating lens 111. The collimating lens causes a generally planar wavefront of light to be incident on the SLM. In FIG. 1, the direction of the wavefront is off-normal (e.g. two or three degrees away from being truly orthogonal to the plane of the transparent layer). However, in other embodiments, the generally planar wavefront is provided at normal incidence and a beam splitter arrangement is used to separate the input and output optical paths. In the embodiment shown in FIG. 1, the arrangement is such that light from the light source is reflected off a mirrored rear surface of the SLM and interacts with a light-modulating layer to form an exit wavefront 112. The exit wavefront 112 is applied to optics including a Fourier transform lens 120, having its focus at a screen 125. More specifically, the Fourier transform lens 120 receives a beam of modulated light from the SLM 140 and performs a frequency-space transformation to produce a holographic reconstruction at the screen 125.

Notably, in this type of holography, each pixel of the hologram contributes to the whole reconstruction. There is not a one-to-one correlation between specific points (or image pixels) on the replay field and specific light-modulating elements (or hologram pixels). In other words, modulated light exiting the light-modulating layer is distributed across the replay field.

In these embodiments, the position of the holographic reconstruction in space is determined by the dioptric (focusing) power of the Fourier transform lens. In the embodiment shown in FIG. 1, the Fourier transform lens is a physical lens. That is, the Fourier transform lens is an optical Fourier transform lens and the Fourier transform is performed optically. Any lens can act as a Fourier transform lens but the performance of the lens will limit the accuracy of the Fourier transform it performs. The skilled person understands how to use a lens to perform an optical Fourier transform In some embodiments of the present disclosure, the lens of the viewer's eye performs the hologram to image transformation.

### Hologram Calculation

In some embodiments, the computer-generated hologram is a Fourier transform hologram, or simply a Fourier hologram or Fourier-based hologram, in which an image is reconstructed in the far field by utilising the Fourier transforming properties of a positive lens. The Fourier hologram is calculated by Fourier transforming the desired light field in the replay plane back to the lens plane. Computer-generated Fourier holograms may be calculated using Fourier transforms. Embodiments relate to Fourier holography and Gerchberg-Saxton type algorithms by way of example only. The present disclosure is equally applicable to Fresnel holography and Fresnel holograms which may be calculated by a similar method. In some embodiments, the hologram is a phase or phase-only hologram. However, the present disclosure is also applicable to holograms calculated by other techniques such as those based on point cloud methods.

In some embodiments, the hologram engine is arranged to exclude from the hologram calculation the contribution of light blocked by a limiting aperture of the display system. British patent application 2101666.2, filed 5 Feb. 2021 and incorporated herein by reference, discloses a first hologram calculation method in which eye-tracking and ray tracing are used to identify a sub-area of the display device for calculation of a point cloud hologram which eliminates ghost images. The sub-area of the display device corresponds with the aperture, of the present disclosure, and is used exclude light paths from the hologram calculation. British patent application 2112213.0, filed 26 Aug. 2021 and incorporated herein by reference, discloses a second method based on a modified Gerchberg-Saxton type algorithm which includes steps of light field cropping in accordance with pupils of the optical system during hologram calculation. The cropping of the light field corresponds with the determination of a limiting aperture of the present disclosure. British patent application 2118911.3, filed 23 Dec. 2021 and also incorporated herein by reference, discloses a third method of calculating a hologram which includes a step of determining a region of a so-called extended modulator formed by a hologram replicator. The region of the extended modulator is also an aperture in accordance with this disclosure.

In some embodiments, there is provided a real-time engine arranged to receive image data and calculate holograms in real-time using the algorithm. In some embodiments, the image data is a video comprising a sequence of image frames. In other embodiments, the holograms are pre-calculated, stored in computer memory and recalled as needed for display on a SLM. That is, in some embodiments, there is provided a repository of predetermined holograms.

### Large Field of View Using Small Display Device

Broadly, the present disclosure relates to image projection. It relates to a method of image projection and an image projector which comprises a display device. The present disclosure also relates to a projection system comprising the image projector and a viewing system, in which the image projector projects or relays light from the display device to the viewing system. The present disclosure is equally applicable to a monocular and binocular viewing system. The viewing system may comprise a viewer's eye or eyes. The viewing system comprises an optical element having optical power (e.g., lens/es of the human eye) and a viewing plane (e.g., retina of the human eye/s). The projector may be referred to as a ‘light engine’. The display device and the image formed (or perceived) using the display device are spatially separated from one another. The image is formed, or perceived by a viewer, on a display plane. In some embodiments, the image is a virtual image and the display plane may be referred to as a virtual image plane. In other examples, the image is a real image formed by holographic reconstruction and the image is projected or relayed to the viewing plane. In these other examples, spatially modulated light of an intermediate holographic reconstruction formed either in free space or on a screen or other light receiving surface between the display device and the viewer, is propagated to the viewer. In both cases, an image is formed by illuminating a diffractive pattern (e.g., hologram or kinoform) displayed on the display device.

The display device comprises pixels. The pixels of the display may display a diffractive pattern or structure that diffracts light. The diffracted light may form an image at a plane spatially separated from the display device. In accordance with well-understood optics, the magnitude of the maximum diffraction angle is determined by the size of the pixels and other factors such as the wavelength of the light.

In embodiments, the display device is a spatial light modulator such as liquid crystal on silicon (“LCOS”) spatial light modulator (SLM). Light propagates over a range of diffraction angles (for example, from zero to the maximum diffractive angle) from the LCOS, towards a viewing entity/system such as a camera or an eye. In some embodiments, magnification techniques may be used to increase the range of available diffraction angles beyond the conventional maximum diffraction angle of an LCOS.

In some embodiments, the (light of a) hologram itself is propagated to the eyes. For example, spatially modulated light of the hologram (that has not yet been fully transformed to a holographic reconstruction, i.e. image)—that may be informally said to be “encoded” with/by the hologram—is propagated directly to the viewer's eyes. A real or virtual image may be perceived by the viewer. In these embodiments, there is no intermediate holographic reconstruction/image formed between the display device and the viewer. It is sometimes said that, in these embodiments, the lens of the eye performs a hologram-to-image conversion or transform. The projection system, or light engine, may be configured so that the viewer effectively looks directly at the display device.

Reference is made herein to a “light field” which is a “complex light field”. The term “light field” merely indicates a pattern of light having a finite size in at least two orthogonal spatial directions, e.g. x and y. The word “complex” is used herein merely to indicate that the light at each point in the light field may be defined by an amplitude value and a phase value, and may therefore be represented by a complex number or a pair of values. For the purpose of hologram calculation, the complex light field may be a two-dimensional array of complex numbers, wherein the complex numbers define the light intensity and phase at a plurality of discrete locations within the light field.

In accordance with the principles of well-understood optics, the range of angles of light propagating from a display device that can be viewed, by an eye or other viewing entity/system, varies with the distance between the display device and the viewing entity. At a 1 metre viewing distance, for example, only a small range of angles from an LCOS can propagate through an eye's pupil to form an image at the retina for a given eye position. The range of angles of light rays that are propagated from the display device, which can successfully propagate through an eye's pupil to form an image at the retina for a given eye position, determines the portion of the image that is ‘visible’ to the viewer. In other words, not all parts of the image are visible from any one point on the viewing plane (e.g., any one eye position within a viewing window such as eye-box.)

In some embodiments, the image perceived by a viewer is a virtual image that appears upstream of the display device—that is, the viewer perceives the image as being further away from them than the display device. Conceptually, it may therefore be considered that the viewer is looking at a virtual image through an ‘display device-sized window’, which may be very small, for example 1 cm in diameter, at a relatively large distance, e.g., 1 metre. And the user will be viewing the display device-sized window via the pupil(s) of their eye(s), which can also be very small. Accordingly, the field of view becomes small and the specific angular range that can be seen depends heavily on the eye position, at any given time.

A pupil expander addresses the problem of how to increase the range of angles of light rays that are propagated from the display device that can successfully propagate through an eye's pupil to form an image. The display device is generally (in relative terms) small and the projection distance is (in relative terms) large. In some embodiments, the projection distance is at least one-such as, at least two-orders of magnitude greater than the diameter, or width, of the entrance pupil and/or aperture of the display device (i.e., size of the array of pixels).

Use of a pupil expander increases the viewing area (i.e., user's eye-box) laterally, thus enabling some movement of the eye/s to occur, whilst still enabling the user to see the image. As the skilled person will appreciate, in an imaging system, the viewing area (user's eye box) is the area in which a viewer's eyes can perceive the image. The present disclosure encompasses non-infinite virtual image distances—that is, near-field virtual images.

Conventionally, a two-dimensional pupil expander comprises one or more one-dimensional optical waveguides each formed using a pair of opposing reflective surfaces, in which the output light from a surface forms a viewing window or eye-box. Light received from the display device (e.g., spatially modulated light from a LCOS) is replicated by the or each waveguide so as to increase the field of view (or viewing area) in at least one dimension. In particular, the waveguide enlarges the viewing window due to the generation of extra rays or “replicas” by division of amplitude of the incident wavefront.

The display device may have an active or display area having a first dimension that may be less than 10 cms such as less than 5 cms or less than 2 cms. The propagation distance between the display device and viewing system may be greater than 1 m such as greater than 1.5 m or greater than 2 m. The optical propagation distance within the waveguide may be up to 2 m such as up to 1.5 m or up to 1 m. The method may be capable of receiving an image and determining a corresponding hologram of sufficient quality in less than 20 ms such as less than 15 ms or less than 10 ms.

In some embodiments-described only by way of example of a diffracted or holographic light field in accordance with this disclosure-a hologram is configured to route light into a plurality of channels, each channel corresponding to a different part (i.e. sub-area) of an image. The channels formed by the diffractive structure are referred to herein as “hologram channels” merely to reflect that they are channels of light encoded by the hologram with image information. It may be said that the light of each channel is in the hologram domain rather than the image or spatial domain. In some embodiments, the hologram is a Fourier or Fourier transform hologram and the hologram domain is therefore the Fourier or frequency domain. The hologram may equally be a Fresnel or Fresnel transform hologram. The hologram may also be a point cloud hologram. The hologram is described herein as routing light into a plurality of hologram channels to reflect that the image that can be reconstructed from the hologram has a finite size and can be arbitrarily divided into a plurality of image sub-areas, wherein each hologram channel would correspond to each image sub-area. Importantly, the hologram of this example is characterised by how it distributes the image content when illuminated. Specifically and uniquely, the hologram divides the image content by angle. That is, each point on the image is associated with a unique light ray angle in the spatially modulated light formed by the hologram when illuminated—at least, a unique pair of angles because the hologram is two-dimensional. For the avoidance of doubt, this hologram behaviour is not conventional. The spatially modulated light formed by this special type of hologram, when illuminated, may be divided into a plurality of hologram channels, wherein each hologram channel is defined by a range of light ray angles (in two-dimensions). It will be understood from the foregoing that any hologram channel (i.e. sub-range of light ray angles) that may be considered in the spatially modulated light will be associated with a respective part or sub-area of the image. That is, all the information needed to reconstruct that part or sub-area of the image is contained within a sub-range of angles of the spatially modulated light formed from the hologram of the image. When the spatially modulated light is observed as a whole, there is not necessarily any evidence of a plurality of discrete light channels.

Nevertheless, the hologram may still be identified. For example, if only a continuous part or sub-area of the spatially modulated light formed by the hologram is reconstructed, only a sub-area of the image should be visible. If a different, continuous part or sub-area of the spatially modulated light is reconstructed, a different sub-area of the image should be visible. A further identifying feature of this type of hologram is that the shape of the cross-sectional area of any hologram channel substantially corresponds to (i.e. is substantially the same as) the shape of the entrance pupil although the size may be different—at least, at the correct plane for which the hologram was calculated. Each light/hologram channel propagates from the hologram at a different angle or range of angles. Whilst these are example ways of characterising or identifying this type of hologram, other ways may be used. In summary, the hologram disclosed herein is characterised and identifiable by how the image content is distributed within light encoded by the hologram. Again, for the avoidance of any doubt, reference herein to a hologram configured to direct light or angularly-divide an image into a plurality of hologram channels is made by way of example only and the present disclosure is equally applicable to pupil expansion of any type of holographic light field or even any type of diffractive or diffracted light field.

The system can be provided in a compact and streamlined physical form. This enables the system to be suitable for a broad range of real-world applications, including those for which space is limited and real-estate value is high. For example, it may be implemented in a head-up display (HUD) such as a vehicle or automotive HUD.

In accordance with the present disclosure, pupil expansion is provided for diffracted or diffractive light, which may comprise diverging ray bundles. The diffracted light field may be defined by a “light cone”. Thus, the size of the diffracted light field (as defined on a two-dimensional plane) increases with propagation distance from the corresponding diffractive structure (i.e. display device). It can be said that the pupil expander/s replicate the hologram or form at least one replica of the hologram, to convey that the light delivered to the viewer is spatially modulated in accordance with a hologram.

In some embodiments, two one-dimensional waveguide pupil expanders are provided, each one-dimensional waveguide pupil expander being arranged to effectively increase the size of the exit pupil of the system by forming a plurality of replicas or copies of the exit pupil (or light of the exit pupil) of the spatial light modulator. The exit pupil may be understood to be the physical area from which light is output by the system. It may also be said that each waveguide pupil expander is arranged to expand the size of the exit pupil of the system. It may also be said that each waveguide pupil expander is arranged to expand/increase the size of the eye box within which a viewer's eye can be located, in order to see/receive light that is output by the system.

### Light Channeling

The hologram formed in accordance with some embodiments, angularly-divides the image content to provide a plurality of hologram channels which may have a cross-sectional shape defined by an aperture of the optical system. The hologram is calculated to provide this channeling of the diffracted light field. In some embodiments, this is achieved during hologram calculation by considering an aperture (virtual or real) of the optical system, as described above.

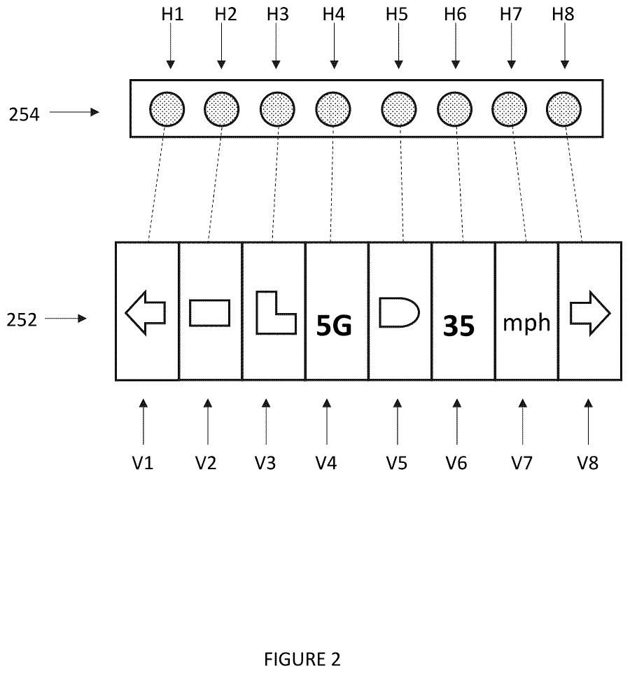

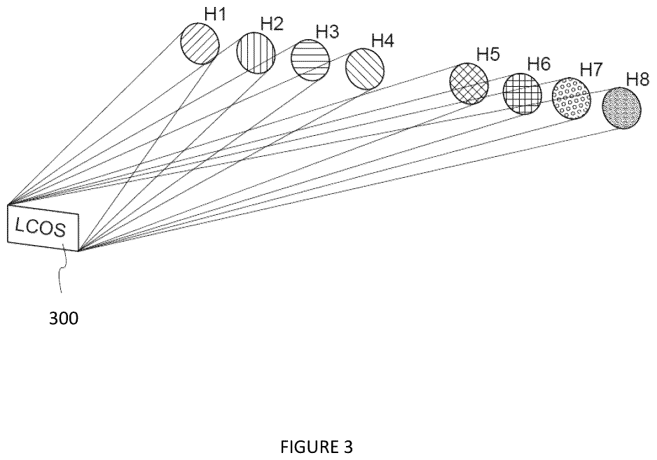

FIGS. 2 and 3 show an example of this type of hologram that may be used in conjunction with a pupil expander as disclosed herein. However, this example should not be regarded as limiting with respect to the present disclosure.

FIG. 2 shows an image 252 for projection comprising eight image areas/components, V1 to V8. FIG. 2 shows eight image components by way of example only and the image 252 may be divided into any number of components. FIG. 2 also shows an encoded light pattern 254 (i.e., hologram) that can reconstruct the image 252—e.g., when transformed by the lens of a suitable viewing system. The encoded light pattern 254 comprises first to eighth sub-holograms or components, H1 to H8, corresponding to the first to eighth image components/areas, V1 to V8. FIG. 2 further shows how a hologram may decompose the image content by angle. The hologram may therefore be characterised by the channeling of light that it performs. This is illustrated in FIG. 3. Specifically, the hologram in this example directs light into a plurality of discrete areas. The discrete areas are discs in the example shown but other shapes are envisaged. The size and shape of the optimum disc may, after propagation through the waveguide, be related to the size and shape of an aperture of the optical system such as the entrance pupil of the viewing system.

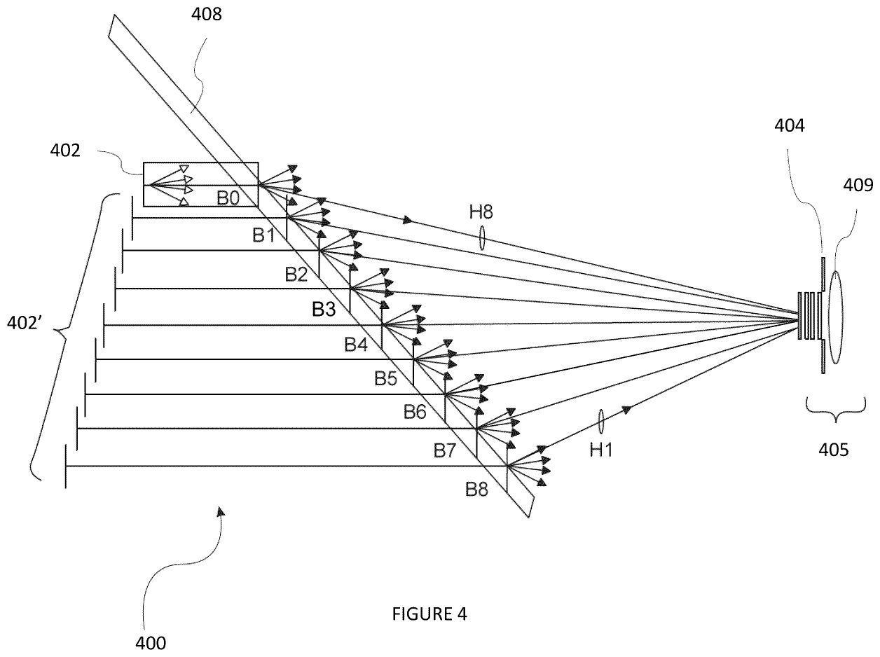

FIG. 4 shows a system 400, including a display device that displays a hologram that has been calculated as illustrated in FIGS. 2 and 3.

The system 400 comprises a display device, which in this arrangement comprises an LCOS 402. The LCOS 402 is arranged to display a modulation pattern (or ‘diffractive pattern’) comprising the hologram and to project light that has been holographically encoded towards an eye 405 that comprises a pupil that acts as an aperture 404, a lens 409, and a retina (not shown) that acts as a viewing plane. There is a light source (not shown) arranged to illuminate the LCOS 402. The lens 409 of the eye 405 performs a hologram-to-image transformation. The light source may be of any suitable type. For example, it may comprise a laser light source.

The viewing system 400 further comprises a waveguide 408 positioned between the LCOS 402 and the eye 405. The presence of the waveguide 408 enables all angular content from the LCOS 402 to be received by the eye, even at the relatively large projection distance shown. This is because the waveguide 508 acts as a pupil expander, in a manner that is well known and so is described only briefly herein.

In brief, the waveguide 408 shown in FIG. 4 comprises a substantially elongate formation. In this example, the waveguide 408 comprises an optical slab of refractive material, but other types of waveguide are also well known and may be used. The waveguide 408 is located so as to intersect the light cone (i.e., the diffracted light field) that is projected from the LCOS 402, for example at an oblique angle. In this example, the size, location, and position of the waveguide 408 are configured to ensure that light from each of the eight ray bundles, within the light cone, enters the waveguide 408. Light from the light cone enters the waveguide 408 via its first planar surface (located nearest the LCOS 402) and is guided at least partially along the length of the waveguide 408, before being emitted via its second planar surface, substantially opposite the first surface (located nearest the eye). As will be well understood, the second planar surface is partially reflective, partially transmissive. In other words, when each ray of light travels within the waveguide 408 from the first planar surface and hits the second planar surface, some of the light will be transmitted out of the waveguide 408 and some will be reflected by the second planar surface, back towards the first planar surface. The first planar surface is reflective, such that all light that hits it, from within the waveguide 408, will be reflected back towards the second planar surface. Therefore, some of the light may simply be refracted between the two planar surfaces of the waveguide 408 before being transmitted, whilst other light may be reflected, and thus may undergo one or more reflections, (or ‘bounces’) between the planar surfaces of the waveguide 408, before being transmitted.

FIG. 4 shows a total of nine “bounce” points, B0 to B8, along the length of the waveguide 408. Although light relating to all points of the image (V1-V8) as shown in FIG. 2 is transmitted out of the waveguide at each “bounce” from the second planar surface of the waveguide 408, only the light from one angular part of the image (e.g. light of one of V1 to V8) has a trajectory that enables it to reach the eye 405, from each respective “bounce” point, B0 to B8. Moreover, light from a different angular part of the image, V1 to V8, reaches the eye 405 from each respective “bounce” point. Therefore, each angular channel of encoded light reaches the eye only once, from the waveguide 408, in the example of FIG. 4.

The waveguide 408 forms a plurality of replicas of the hologram, at the respective “bounce” points B1 to B8 along its length, corresponding to the direction of pupil expansion. As shown in FIG. 4, the plurality of replicas may be extrapolated back, in a straight line, to a corresponding plurality of replica or virtual display devices 402′. This process corresponds to the step of “unfolding” an optical path within the waveguide, so that a light ray of a replica is extrapolated back to a “virtual surface” without internal reflection within the waveguide. Thus, the light of the expanded exit pupil may be considered to originate from a virtual surface (also called an “extended modulator” herein) comprising the display device 402 and the replica display devices 402′.

Although virtual images, which require the eye to transform received modulated light in order to form a perceived image, have generally been discussed herein, the methods and arrangements described herein can be applied to real images.

### Two-Dimensional Pupil Expansion

Whilst the arrangement shown in FIG. 4 includes a single waveguide that provides pupil expansion in one dimension, pupil expansion can be provided in more than one dimension, for example in two dimensions. Moreover, whilst the example in FIG. 4 uses a hologram that has been calculated to create channels of light, each corresponding to a different portion of an image, the present disclosure and the systems that are described herebelow are not limited to such a hologram type.

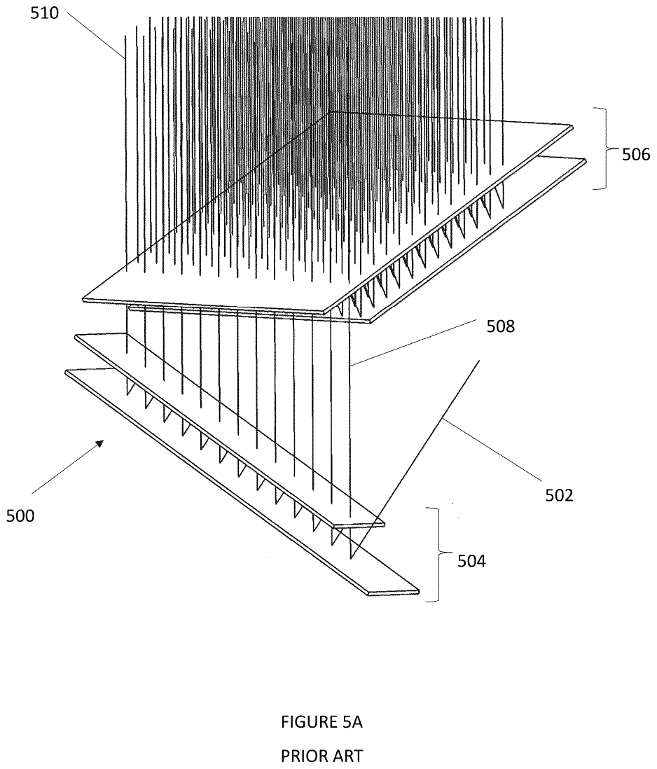

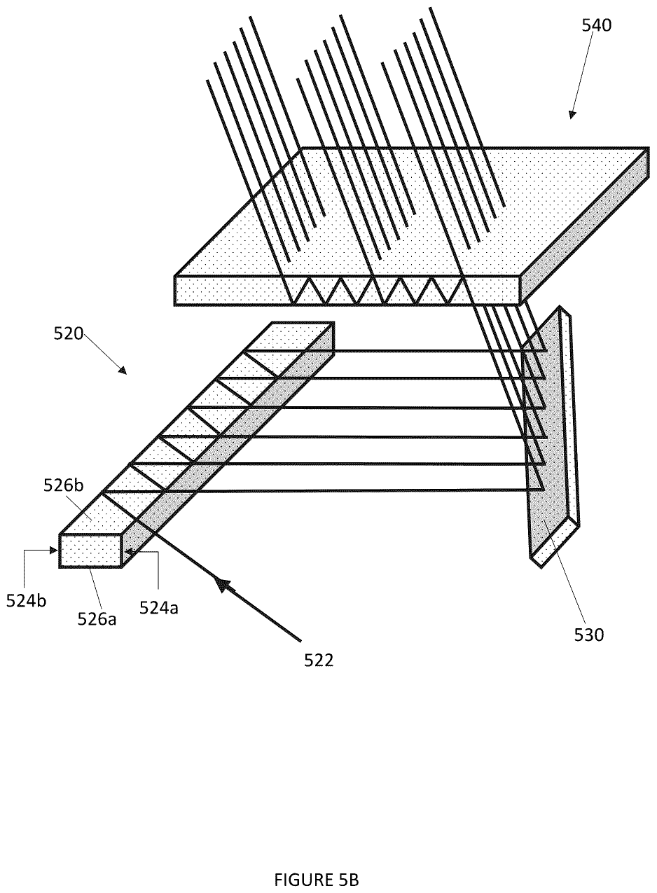

FIG. 5A shows a perspective view of a system 500 comprising two replicators, 504, 506 arranged for expanding a light beam 502 in two dimensions.

In the system 500 of FIG. 5A, the first replicator 504 comprises a first pair of surfaces, stacked parallel to one another, and arranged to provide replication—or, pupil expansion—in a similar manner to the waveguide 408 of FIG. 4. The first pair of surfaces are similarly (in some cases, identically) sized and shaped to one another and are substantially elongate in one direction. The collimated light beam 502 is directed towards an input on the first replicator 504. Due to a process of internal reflection between the two surfaces, and partial transmission of light from each of a plurality of output points on one of the surfaces (the upper surface, as shown in FIG. 5A), which will be familiar to the skilled reader, light of the light beam 502 is replicated in a first direction, along the length of the first replicator 504. Thus, a first plurality of replica light beams 508 is emitted from the first replicator 504, towards the second replicator 506.

The second replicator 506 comprises a second pair of surfaces stacked parallel to one another, arranged to receive each of the collimated light beams of the first plurality of light beams 508 and further arranged to provide replication—or, pupil expansion—by expanding each of those light beams in a second direction, substantially orthogonal to the first direction. The first pair of surfaces are similarly (in some cases, identically) sized and shaped to one another and are substantially rectangular. The rectangular shape is implemented for the second replicator in order for it to have length along the first direction, in order to receive the first plurality of light beams 508, and to have length along the second, orthogonal direction, in order to provide replication in that second direction. Due to a process of internal reflection between the two surfaces, and partial transmission of light from each of a plurality of output points on one of the surfaces (the upper surface, as shown in FIG. 5A), light of each light beam within the first plurality of light beams 508 is replicated in the second direction. Thus, a second plurality of light beams 510 is emitted from the second replicator 506, wherein the second plurality of light beams 510 comprises replicas of the input light beam 502 along each of the first direction and the second direction. Thus, the second plurality of light beams 510 may be regarded as comprising a two-dimensional grid, or array, of replica light beams.

Thus, it can be said that the first and second replicators 504, 505 of FIG. 5A combine to provide a two-dimensional replicator (or, “two-dimensional pupil expander”). Thus, the replica light beams 510 may be emitted along an optical path to an expanded eye-box of a display system, such as a head-up display.

In the system of FIG. 5A, the first replicator 504 is a waveguide comprising a pair of elongate rectilinear reflective surfaces, stacked parallel to one another, and, similarly, the second replicator 504 is a waveguide comprising a pair of rectangular reflective surfaces, stacked parallel to one another. In other systems, the first replicator may be a solid elongate rectilinear waveguide and the second replicator may be a solid planar rectangular shaped waveguide, wherein each waveguide comprises an optically transparent solid material such as glass. In this case, the pair of parallel reflective surfaces are formed by a pair of opposed major sidewalls optionally comprising respective reflective and reflective-transmissive surface coatings, familiar to the skilled reader.

FIG. 5B shows a perspective view of a system 500 comprising two replicators, 520, 540 arranged for replicating a light beam 522 in two dimensions, in which the first replicator is a solid elongated waveguide 520 and the second replicator is a solid planar waveguide 540.

In the system of FIG. 5B, the first replicator/waveguide 520 is arranged so that its pair of elongate parallel reflective surfaces 524a, 524b are perpendicular to the plane of the second replicator/waveguide 540. Accordingly, the system comprises an optical coupler arranged to couple light from an output port of first replicator 520 into an input port of the second replicator 540. In the illustrated arrangement, the optical coupler is a planar/fold mirror 530 arranged to fold or turn the optical path of light to achieve the required optical coupling from the first replicator to the second replicator. As shown in FIG. 5B, the mirror 530 is arranged to receive light—comprising a one-dimensional array of replicas extending in the first dimension—from the output port/reflective-transmissive surface 524a of the first replicator/waveguide 520. The mirror 530 is tilted so as to redirect the received light onto an optical path to an input port in the (fully) reflective surface of second replicator 540 at an angle to provide waveguiding and replica formation, along its length in the second dimension. It will be appreciated that the mirror 530 is one example of an optical element that can redirect the light in the manner shown, and that one or more other elements may be used instead, to perform this task.

In the illustrated arrangement, the (partially) reflective-transmissive surface 524a of the first replicator 520 is adjacent the input port of the first replicator/waveguide 520 that receives input beam 522 at an angle to provide waveguiding and replica formation, along its length in the first dimension. Thus, the input port of first replicator/waveguide 520 is positioned at an input end thereof at the same surface as the reflective-transmissive surface 524a. The skilled reader will understand that the input port of the first replicator/waveguide 520 may be at any other suitable position.

Accordingly, the arrangement of FIG. 5B enables the first replicator 520 and the mirror 530 to be provided as part of a first relatively thin layer in a plane in the first and third dimensions (illustrated as an x-z plane). In particular, the size or “height” of a first planar layer—in which the first replicator 520 is located—in the second dimension (illustrated as the y dimension) is reduced. The mirror 530 is configured to direct the light away from a first layer/plane, in which the first replicator 520 is located (i.e. the “first planar layer”), and direct it towards a second layer/plane, located above and substantially parallel to the first layer/plane, in which the second replicator 540 is located (i.e. a “second planar layer”). Thus, the overall size or “height” of the system—comprising the first and second replicators 520, 540 and the mirror 530 located in the stacked first and second planar layers in the first and third dimensions (illustrated as an x-z plane)—in the second dimension (illustrated as the y dimension) is compact. The skilled reader will understand that many variations of the arrangement of FIG. 5B for implementing the present disclosure are possible and contemplated.

The image projector may be arranged to project a diverging or diffracted light field. In some embodiments, the light field is encoded with a hologram. In some embodiments, the diffracted light field comprises diverging ray bundles. In some embodiments, the image formed by the diffracted light field is a virtual image.

In some embodiments, the first pair of parallel/complementary surfaces are elongate or elongated surfaces, being relatively long along a first dimension and relatively short along a second dimension, for example being relatively short along each of two other dimensions, with each dimension being substantially orthogonal to each of the respective others. The process of reflection/transmission of the light between/from the first pair of parallel surfaces is arranged to cause the light to propagate within the first waveguide pupil expander, with the general direction of light propagation being in the direction along which the first waveguide pupil expander is relatively long (i.e., in its “elongate” direction).

There is disclosed herein a system that forms an image using diffracted light and provides an eye-box size and field of view suitable for real-world application—e.g. in the automotive industry by way of a head-up display. The diffracted light is light forming a holographic reconstruction of the image from a diffractive structure—e.g. hologram such as a Fourier or Fresnel hologram. The use diffraction and a diffractive structure necessitates a display device with a high density of very small pixels (e.g. 1 micrometer)—which, in practice, means a small display device (e.g. 1 cm). The inventors have addressed a problem of how to provide 2D pupil expansion with a diffracted light field e.g. diffracted light comprising diverging (not collimated) ray bundles.

In some embodiments, the display system comprises a display device-such as a pixelated display device, for example a spatial light modulator (SLM) or Liquid Crystal on Silicon (LCoS) SLM-which is arranged to provide or form the diffracted or diverging light. In such aspects, the aperture of the spatial light modulator (SLM) is a limiting aperture of the system. That is, the aperture of the spatial light modulator—more specifically, the size of the area delimiting the array of light modulating pixels comprised within the SLM-determines the size (e.g. spatial extent) of the light ray bundle that can exit the system. In accordance with this disclosure, it is stated that the exit pupil of the system is expanded to reflect that the exit pupil of the system (that is limited by the small display device having a pixel size for light diffraction) is made larger or bigger or greater in spatial extend by the use of at least one pupil expander.

The diffracted or diverging light field may be said to have “a light field size”, defined in a direction substantially orthogonal to a propagation direction of the light field. Because the light is diffracted/diverging, the light field size increases with propagation distance.

In some embodiments, the diffracted light field is spatially-modulated in accordance with a hologram. In other words, in such aspects, the diffractive light field comprises a “holographic light field”. The hologram may be displayed on a pixelated display device. The hologram may be a computer-generated hologram (CGH). It may be a Fourier hologram or a Fresnel hologram or a point-cloud hologram or any other suitable type of hologram. The hologram may, optionally, be calculated so as to form channels of hologram light, with each channel corresponding to a different respective portion of an image that is intended to be viewed (or perceived, if it is a virtual image) by the viewer. The pixelated display device may be configured to display a plurality of different holograms, in succession or in sequence. Each of the aspects and embodiments disclosed herein may be applied to the display of multiple holograms.

The output port of the first waveguide pupil expander may be coupled to an input port of a second waveguide pupil expander. The second waveguide pupil expander may be arranged to guide the diffracted light field—including some of, preferably most of, preferably all of, the replicas of the light field that are output by the first waveguide pupil expander—from its input port to a respective output port by internal reflection between a third pair of parallel surfaces of the second waveguide pupil expander.

The first waveguide pupil expander may be arranged to provide pupil expansion, or replication, in a first direction and the second waveguide pupil expander may be arranged to provide pupil expansion, or replication, in a second, different direction. The second direction may be substantially orthogonal to the first direction. The second waveguide pupil expander may be arranged to preserve the pupil expansion that the first waveguide pupil expander has provided in the first direction and to expand (or, replicate) some of, preferably most of, preferably all of, the replicas that it receives from the first waveguide pupil expander in the second, different direction. The second waveguide pupil expander may be arranged to receive the light field directly or indirectly from the first waveguide pupil expander. One or more other elements may be provided along the propagation path of the light field between the first and second waveguide pupil expanders.

The first waveguide pupil expander may be substantially elongated and the second waveguide pupil expander may be substantially planar. The elongated shape of the first waveguide pupil expander may be defined by a length along a first dimension. The planar, or rectangular, shape of the second waveguide pupil expander may be defined by a length along a first dimension and a width, or breadth, along a second dimension substantially orthogonal to the first dimension. A size, or length, of the first waveguide pupil expander along its first dimension make correspond to the length or width of the second waveguide pupil expander along its first or second dimension, respectively. A first surface of the pair of parallel surfaces of the second waveguide pupil expander, which comprises its input port, may be shaped, sized, and/or located so as to correspond to an area defined by the output port on the first surface of the pair of parallel surfaces on the first waveguide pupil expander, such that the second waveguide pupil expander is arranged to receive each of the replicas output by the first waveguide pupil expander.

The first and second waveguide pupil expander may collectively provide pupil expansion in a first direction and in a second direction perpendicular to the first direction, optionally, wherein a plane containing the first and second directions is substantially parallel to a plane of the second waveguide pupil expander. In other words, the first and second dimensions that respectively define the length and breadth of the second waveguide pupil expander may be parallel to the first and second directions, respectively, (or to the second and first directions, respectively) in which the waveguide pupil expanders provide pupil expansion. The combination of the first waveguide pupil expander and the second waveguide pupil expander may be generally referred to as being a “pupil expander”.

It may be said that the expansion/replication provided by the first and second waveguide expanders has the effect of expanding an exit pupil of the display system in each of two directions. An area defined by the expanded exit pupil may, in turn define an expanded eye-box area, from which the viewer can receive light of the input diffracted or diverging light field. The eye-box area may be said to be located on, or to define, a viewing plane.

The two directions in which the exit pupil is expanded may be coplanar with, or parallel to, the first and second directions in which the first and second waveguide pupil expanders provide replication/expansion. Alternatively, in arrangements that comprise other elements such as an optical combiner, for example the windscreen (or, windshield) of a vehicle, the exit pupil may be regarded as being an exit pupil from that other element, such as from the windscreen. In such arrangements, the exit pupil may be non-coplanar and non-parallel with the first and second directions in which the first and second waveguide pupil expanders provide replication/expansion. For example, the exit pupil may be substantially perpendicular to the first and second directions in which the first and second waveguide pupil expanders provide replication/expansion.

The viewing plane, and/or the eye-box area, may be non-coplanar or non-parallel to the first and second directions in which the first and second waveguide pupil expanders provide replication/expansion. For example, a viewing plane may be substantially perpendicular to the first and second directions in which the first and second waveguide pupil expanders provide replication/expansion.

In order to provide suitable launch conditions to achieve internal reflection within the first and second waveguide pupil expanders, an elongate dimension of the first waveguide pupil expander may be tilted relative to the first and second dimensions of the second waveguide pupil expander.

### Combiner Shape Compensation

An advantage of projecting a hologram to the eye-box is that optical compensation can be encoded in the hologram (see, for example, European patent 2936252 incorporated herein by reference). The present disclosure is compatible with holograms that compensate for the complex curvature of an optical combiner used as part of the projection system. In some embodiments, the optical combiner is the windscreen of a vehicle. Full details of this approach are provided in European patent 2936252 and are not repeated here because the detailed features of those systems and methods are not essential to the new teaching of this disclosure herein and are merely exemplary of configurations that benefit from the teachings of the present disclosure.

### Control Device

The present disclosure is also compatible with optical configurations that include a control device (e.g. light shuttering device) to control the delivery of light from a light channeling hologram to the viewer. The holographic projector may further comprise a control device arranged to control the delivery of angular channels to the eye-box position. British patent application 2108456.1, filed 14 Jun. 2021 and incorporated herein by reference, discloses the at least one waveguide pupil expander and control device. The reader will understand from at least this prior disclosure that the optical configuration of the control device is fundamentally based upon the eye-box position of the user and is compatible with any hologram calculation method that achieves the light channeling described herein. It may be said that the control device is a light shuttering or aperturing device. The light shuttering device may comprise a 1D array of apertures or windows, wherein each aperture or window independently switchable between a light transmissive and a light non-transmissive state in order to control the delivery of hologram light channels, and their replicas, to the eye-box. Each aperture or window may comprise a plurality of liquid crystal cells or pixels.

### Diffractive Pixel Colour Misalignment Correction

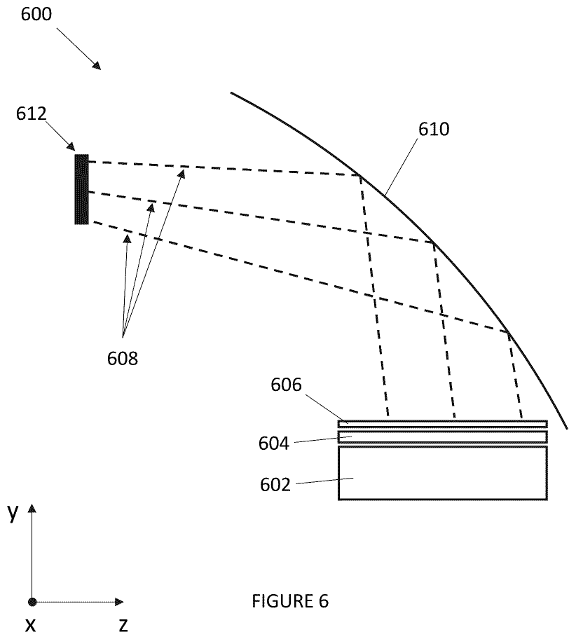

FIG. 6 shows a side schematic view of a display system 600 of a first embodiment of the present disclosure. A waveguide 602 replicates inputted light as per the second waveguide 540 described above. That is, a one-dimensional array (i.e. a line) of replicas in the x-direction are input into the waveguide 602. An output surface of the waveguide 602 emits a two-dimensional array of replicas on the x-z plane that is received by a corrective glare mitigation device 604 (more broadly termed a light control device or a corrective optic). The corrective glare mitigation device 604 reduces the glare that would otherwise reflect off the waveguide 602 towards the user whilst also providing compensation for the complex curvature of a windscreen 610 (more broadly termed an optical component). The function of the corrective glare mitigation device 604 is further described in GB2607672B, GB2627988A and GB2401627.1, which are incorporated herein by reference. The corrective glare mitigation device 604 applies a turn to the replicas output by the waveguide 602 as part of the complex curvature compensation function, as will be described in more detail below.

The replicas output from the corrective glare mitigation device 604 are then received by a diffractive optical element 606, the function of which will be described below. Replicas 608 are emitted from the diffractive optical element 606 towards the windscreen 610. The replicas 608 reflect off the windscreen 610 to arrive at an eye-box 612 (in other words, a viewing window). The eye-box 612 is determined to be the area in which the user can view the replicas 608 to form the desired image to a satisfactory quality and/or with an acceptably low number of optical anomalies or distortions (as decided upon by the designer of the system 600).

In other words, the diffractive optical element 606 is arranged on top of the corrective glare mitigation device 604 (in the y-direction), which is in turn arranged on top of the waveguide 602 (in the y-direction). That is, the optical path the display light takes through the display system 600 is from the waveguide 602 to the corrective glare mitigation device 604, then to the diffractive optical element 606 before being reflected off the windscreen 610 towards the eye-box 612.

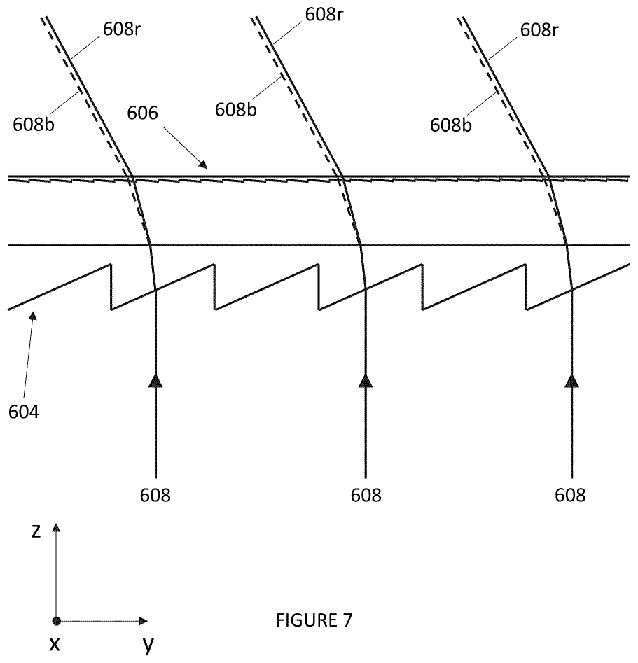

FIG. 7 is a section view of FIG. 6, showing a schematic representation of the path the replicas 608 take through the corrective glare mitigation device 604 and the diffractive optical element 606. The corrective glare mitigation device 604 applies a turn to each replica 608 (by refraction), which helps to correct for the complex curvature of the windscreen 610, as well as to position the eye-box 612 in the correct position for usability and comfort of the viewer. The corrective glare mitigation device 604 also provides the glare mitigation function as described above.

The corrective glare mitigation device 604 is shown as have a series of serrations or prismatic structures on the lower face thereof (the face in the negative z-direction). However, this is merely by example only, and any structure capable of providing the turn, windscreen curvature compensation and glare mitigation functions described above may also be used.

As discussed above, the corrective glare mitigation device 604 applies a turn to each replica 608, however due to the dispersion of its constituent material, a different amount of turn is provided to each wavelength of light of each replica 608. As such, each blue wavelength replica 608b is turned more than each red wavelength replica 608r. In other words, the angle of the turn, taken on the y-z plane in the negative y-direction is larger for the blue wavelength replica 608b than that of the red wavelength replica 608r. As a result of this unequal turn, the blue and red wavelength replicas 608b, 608r are emitted from the corrective glare mitigation device 604 diverging from one another (i.e. in non-parallel directions). It should be noted that, although on the blue and red wavelength replicas 608b, 608r are shown in FIG. 7, the green wavelength replicas would also be turned by a different amount than both of them, the angle of the turn of the green wavelength replicas being between that of the blue and red wavelength replicas 608b, 608r.

The diverging blue and red wavelength replicas 608b, 608r arrive at the diffractive optical element 606 and are turned by said element 606 (by diffraction). As such, it may be said that the turning function required by the display system 600 is provided by the combination of the corrective glare mitigation device 604 and the diffractive optical element 606.

The diffractive optical element 606 is a linear, blazed grating, with the gratings extending in the x-direction. In other words, the diffractive optical element 606 is a series of prismatic structures, the structures extending in the x-direction and arranged in the y-direction, each prismatic structure having a surface facet arranged at a surface angle relative to the y-direction.

As discussed above with regards to the corrective glare mitigation device 604, the diffractive optical element 606 shown in FIG. 7 is merely by example only (i.e., FIG. 7 is schematic), and as such a physical implementation of the device may look different in cross-section.

As with the corrective glare mitigation device 604, the diffractive optical element 606 turns the replicas of different wavelengths by different amounts relative to one another. In this case, each blue wavelength replica 608b is turned less than each red wavelength replica 608r. In other words, the angle of the turn, taken on the y-z plane in the negative y-direction is smaller for the blue wavelength replica 608b than that of the red wavelength replica 608r. The difference in the turn provided by the diffractive optical element 606 is design such that is compensates for (in other words, counteracts) the difference in turn caused by the corrective glare mitigation device 604. As a result, the red and blue wavelength replicas 608r, 608b are emitted from the diffractive optical element 606 parallel to one another.

As such, the red and blue wavelength replicas 608r, 608b will arrive at the eye-box 612 parallel to one another and so there will be a reduction in any colour misalignment in the image visible to the user/viewer. Although FIG. 7 shows the red and blue wavelength replicas 608r, 608b parallel to one another, there is also envisaged an embodiment in which the red and blue wavelength replicas 608r, 608b are not truly parallel to one another, but sufficiently parallel such that the colour misalignment is reduced to an acceptable level as determined by the designer of the system.

As the turn provided by the corrective glare mitigation device 604 and the diffractive optical element 606 is non-linear with respect to wavelength of light, the parallelisation of the replicas can only occur in two wavelengths of light. As such, whilst the red and blue wavelength replicas 608r, 608b may be parallel after being emitted from the diffractive optical element 606, a green replica wavelength (not shown) may be non-parallel. However, the inventors have surprisingly found that the difference in turn between the red and blue wavelength replicas 608r, 608b and each green wavelength replica will still be reduced, and thus so will the green colour misalignment observed by the user.

Each surface facet of the diffractive optical element 606 is arranged at a surface angle relative to the y-direction that will provide a level of turn for specific wavelengths that corresponds to the level of turn for those wavelengths provided by corresponding points of the corrective glare mitigation device 604. The corrective glare mitigation device 604 has a complex profile (to compensate for the varying and complex curvature of the windscreen 610) which provides different levels of turn across its surface, and so in this way the diffractive optical element 606 compensates for the varying turn across the corrective glare mitigation device 604.

This surface angle also has a refraction angle that matches the diffraction angle of the first diffraction order for one wavelength. In this way, the efficiency can be maximised in this first order for this wavelength. The inventors have also surprisingly found that this gives efficiency increases in other wavelengths as well.

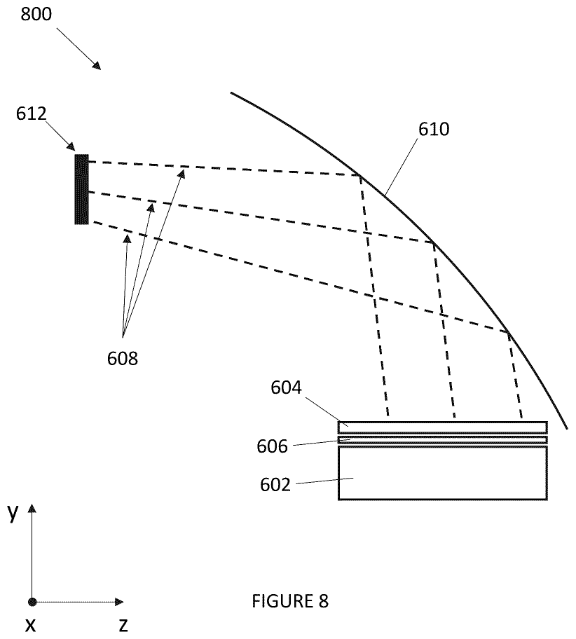

FIG. 8 shows a side schematic view of a display system 800 of a second embodiment of the present disclosure. This embodiment has the same components as discussed in relation to the first embodiment and FIGS. 6 and 7, but in this embodiment the diffractive optical element 606 is located between the waveguide 602 and the corrective glare mitigation device 604. In other words, the optical path the display light takes through the display system 600 is from the waveguide 602 to the diffractive optical element 606, then to the corrective glare mitigation device 604 before being reflected off the windscreen 610 towards the eye-box 612.

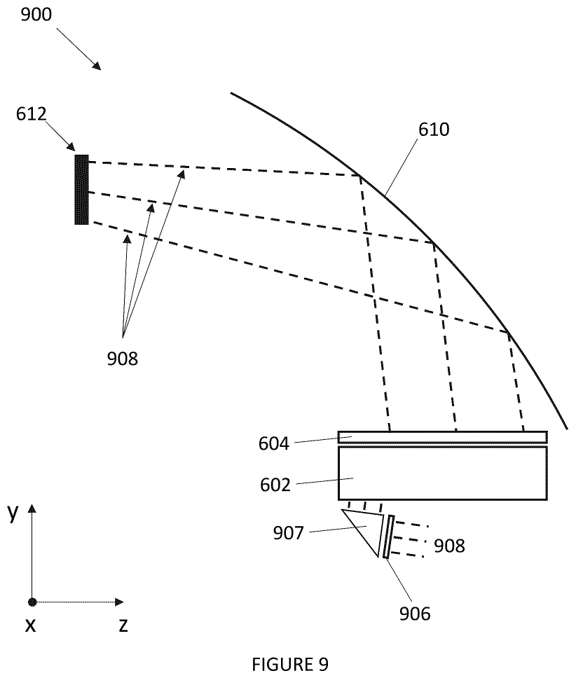

FIG. 9 shows a side schematic view of a display system 900 of a third embodiment of the present disclosure. In this embodiment, a diffractive optical element 906 is located before the waveguide 602 on the optical path through the system 900. As such, the diffractive optical element 906 receives a one-dimensional array of replicas 908 (for example from the first waveguide 520 as described above in relation to FIG. 5). This one-dimensional array of replicas 908 is then turned by the diffractive optical element 906 (as described above in relation to the diffractive optical element 606) before being input into the waveguide 602 (via an optical coupling 907) for waveguiding into a two-dimensional array of replicas 908.

In this embodiment, there is not a one-to-one correspondence between points on the diffractive optical element 906 (and the diffraction therefrom) and points on the corrective glare mitigation device 604 (and the refraction therefrom), and as such the compensation provided by the diffractive optical element 906 will not be as accurate. However, the inventors have surprisingly found that the compensation will still be sufficiently high, and the diffractive optical element 906 will be smaller than in the first embodiment, saving on manufacturing costs and packaging space within the system 900.

FIG. 6, FIG. 7, FIG. 8, and FIG. 9 are schematic and by example only. As such, the skilled person would understand that the relative sizes, proportions and positions of the components may be different in physical implementations of the embodiments shown therein.

### Reactive Mesogen Diffractive Optical Element

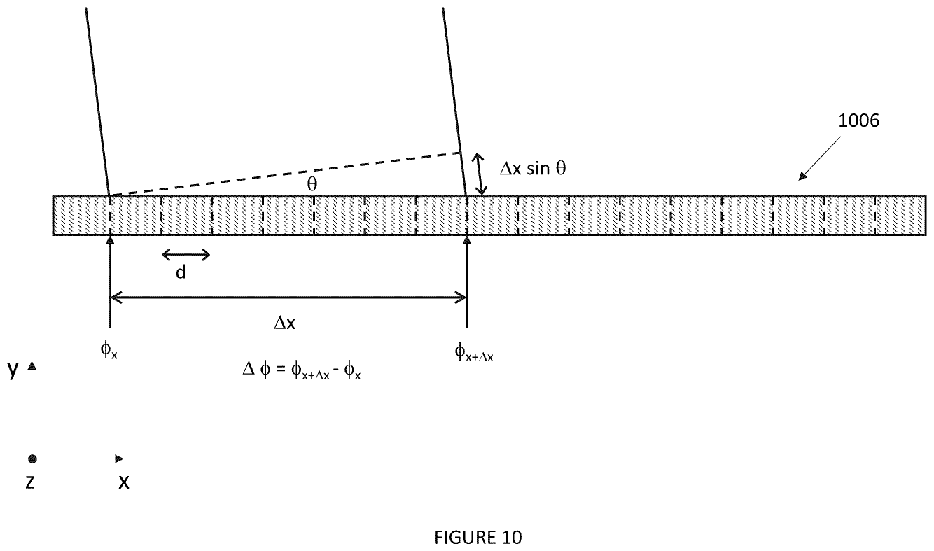

In a fourth embodiment (a variation of the first, second and third embodiments), the diffractive optical element 1006 is formed of a reactive mesogen material that contains polymerizable liquid crystal materials patterned to impart the above-described turn (more specifically, a spatially varying geometric phase retardation) by means of the Pancharatnam-Berry effect. The design of such a reactive mesogen diffractive optical element 1006 is described below in relation to FIG. 10. This turn is independent of wavelength and so can be achieved equally for all wavelengths of replica 608, 908.

The periodicity d of the diffractive optical elements 606, 906 of the first, second and third embodiments produces a turn angle θ for a given single wavelength λ following the diffraction equation:

$$d \cdot sin θ = λ$$

As described above, the turn (i.e. the diffraction) angle θ is dependent on the wavelength λ.

Meanwhile, the direction of the refraction through a reactive mesogen diffractive optical element 1006 is normal to the wavefront emerging therefrom and can be determined such that:

$$( 2 \cdot π / λ ) \cdot Δ x \cdot sin θ = Δ ϕ$$

Where Δx is the length across the reactive mesogen diffractive optical element 1006 for which the refraction is being determined (i.e. the length in the x-direction of FIG. 10) and Δφ is the phase retardation caused by the reactive mesogen diffractive optical element 1006 across the length Δx.

As such, the inventors have surprisingly found that the same turn can be produced by the reactive mesogen diffractive optical element 1006 as the diffractive optical elements 606, 906 of the first, second and third embodiments so long as the linear varying retardance of the reactive mesogen material (that is, the rate at which Δφ changes over Δx) is chosen according to the equation:

$$Δϕ / Δ x = 2 \cdot π / d$$

As this does not have a wavelength dependence, the turn provided by the reactive mesogen diffractive optical element 1006 occurs equally across all wavelengths and so efficiency can be maximised in all wavelengths without the need to prioritise one colour of light.

### Additional Features

The methods and processes described herein may be embodied on a computer-readable medium. The term “computer-readable medium” includes a medium arranged to store data temporarily or permanently such as random-access memory (RAM), read-only memory (ROM), buffer memory, flash memory, and cache memory. The term “computer-readable medium” shall also be taken to include any medium, or combination of multiple media, that is capable of storing instructions for execution by a machine such that the instructions, when executed by one or more processors, cause the machine to perform any one or more of the methodologies described herein, in whole or in part.

The term “computer-readable medium” also encompasses cloud-based storage systems. The term “computer-readable medium” includes, but is not limited to, one or more tangible and non-transitory data repositories (e.g., data volumes) in the example form of a solid-state memory chip, an optical disc, a magnetic disc, or any suitable combination thereof. In some example embodiments, the instructions for execution may be communicated by a carrier medium. Examples of such a carrier medium include a transient medium (e.g., a propagating signal that communicates instructions).

It will be apparent to those skilled in the art that various modifications and variations can be made without departing from the scope of the appended claims. The present disclosure covers all modifications and variations within the scope of the appended claims and their equivalents.

### EXAMPLE EMBODIMENTS

Example 1: A display system comprising:
a replicator arranged to receive spatially modulated light and replicate the spatially modulated light to form a plurality of replicas of the spatially modulated light by waveguiding between a reflective surface and a transmissive-reflective surface, the transmissive-reflective surface forming an output surface for the plurality of replicas of the spatially modulated light;
a light control device located in the optical path of the plurality of replicas of the spatially modulated light downstream from the output surface of the replicator, the light control device being arranged to provide a first angular turn to the replicas of the spatially modulated light, wherein the first angular turn is caused by refractive power and has a primary component on a plane; and a reactive mesogen optical element arranged to provide a second angular turn to the spatially modulated light or the replicas thereof, wherein the second angular turn is caused by diffractive power and has a primary component on the plane;
wherein a chromatic dispersion of the first angular turn caused by the refractive power of the light control device is substantially compensated by a chromatic dispersion of the second angular turn caused by the diffractive power of the reactive mesogen optical element.

Example 2: The display system as defined in Example 1, wherein the chromatic dispersion is a first chromatic dispersion in a first wavelength and a second chromatic dispersion of the first angular turn in a second wavelength caused by the refractive power of the light control device is substantially compensated by the chromatic dispersion of the second angular turn caused by the diffractive power of the reactive mesogen optical element.

Example 3: The display system as defined in Example 2, wherein the first wavelength corresponds to a red wavelength and the second wavelength corresponds to a blue wavelength.

Example 5: The display system as defined in any preceding Example, wherein the reactive mesogen optical element is patterned to impart a phase-delay function by means of the Pancharatnam-Berry effect.

Example 6: The display system as defined in Example 5, wherein the function is a spatially varying geometric phase-delay function.

Example 7: The display system as defined in Example 6, wherein the function is linear.

Example 8: The display system as defined in Example 6 or Example 7, wherein the function is in accordance with the formula Δφ/Δx=2·(π/d), wherein Δx is the differential path length across which the phase-delay is to be determined, Δφ is the change in phase-delay over the path length and d is the grating period of an equivalent linear, blazed diffractive optical element.

Example 9: The display system as defined in any preceding Example, wherein the first angular turn and second angular turn result in a non-zero net angular turn on the plane.

Example 10: The display system as defined in any preceding Example, wherein magnitude of first angular turn is at least ten times that of second angular turn.

Example 11: The display system as defined in any preceding Example, wherein the refractive power of the light control device and the diffractive power of the reactive mesogen optical element are non-uniform.

Example 12: The display system as defined in any preceding Example, wherein the reactive mesogen optical element is located downstream of the light control device.

Example 13: The display system as defined in any of Examples 1 to 11, wherein the reactive mesogen optical element is located downstream of the replicator and upstream of the light control device.

Example 14: The display system as defined in any of Examples 1 to 11, wherein the reactive mesogen optical element is located upstream of the replicator.

Example 15: The display system as defined in any of Examples 1 to 13, wherein the refractive power of the light control device and the diffractive power of the reactive mesogen optical element are functions of the position on the output surface.

Example 16: The display system as defined in any preceding Example, wherein the light control device is a Fresnel structure, is part of a Fresnel lens or is a Fresnel lens.

Example 17: The display system as defined in any preceding Example further comprising a curved optical component downstream from the light control device, wherein the light control device has an opposite lensing effect of the curved optical element, optionally wherein the curved optical component is an optical combiner, such as a windscreen of a vehicle.

Example 18: The display system as defined in Example 17, wherein the light control device is arranged to compensate for the curvature of the curved optical component, wherein the compensation is a function of the position on the output surface.

Example 19: The display system as defined in Example 18, wherein the compensation has negative optical power.

Example 20: The display system as defined in Example 18 or Example 19, wherein the compensation is a phase function, optionally a phase-delay function.

Example 21: The display system as defined in any preceding Example, wherein the spatially modulated light is a holographic wavefront and the replicator is arranged to form a plurality of replicas of the holographic wavefront.

Example 22: The display system as defined in any preceding Example, wherein the light is spatially modulated in accordance with a picture.

Example 23: The display system as defined in any of Examples 1 to 21, wherein the light is spatially modulated in accordance with a hologram of a picture, optionally wherein the hologram is arranged to divide the spatial content of the picture by angle such that angles of the spatially modulated light correspond to spatial coordinates of the picture, optionally further comprising a numerical aperture expander, such as a diffuser, arranged to increase a numerical aperture of the spatially modulated light received by the replicator.

Example 24: A method of display comprising:
receiving spatially modulated light at a replicator;
replicating the spatially modulated light via the replicator to form a plurality of replicas of the spatially modulated light by waveguiding between a reflective surface and a transmissive-reflective surface, the transmissive-reflective surface forming an output surface for the plurality of replicas of the spatially modulated light; and
providing a first angular turn to the replicas of the spatially modulated light via a light control device located in the optical path of the plurality of replicas of the spatially modulated light downstream from the output surface of the replicator, wherein the first angular turn is caused by refractive power and has a primary component on a plane;
the method further comprising:
providing a second angular turn to the spatially modulated light or the replicas thereof via a reactive mesogen optical element, wherein the second angular turn is caused by diffractive power and has a primary component on the plane; and
substantially compensating a chromatic dispersion of the first angular turn caused by the refractive power of the light control device by a chromatic dispersion of the second angular turn caused by the diffractive power of the reactive mesogen optical element.

Example 25: A method of manufacturing a reactive mesogen optical element for use in a display system, the reactive mesogen optical element comprising at least one section having a differential path length Δx, and the method comprising patterning each section to impart a phase-delay according to the function Δφ/Δx=2·(π/d), wherein Δφ is the phase-delay required across the differential path length Δx of each section and d is the grating period required for each section of an equivalent linear diffractive grating.

What is claimed is:

1. A display system comprising:
a replicator arranged to receive spatially modulated light and replicate the spatially modulated light to form a plurality of replicas of the spatially modulated light by waveguiding between a reflective surface and a transmissive-reflective surface, wherein the transmissive-reflective surface forms an output surface for the plurality of replicas of the spatially modulated light;
a light control device located in an optical path of the plurality of replicas of the spatially modulated light downstream from the output surface of the replicator, wherein the light control device is arranged to provide a first angular turn to the plurality of replicas of the spatially modulated light, and wherein the first angular turn is caused by refractive power and has a primary component on a plane;
a diffractive optical element arranged to provide a second angular turn to at least one of the spatially modulated light or the plurality of replicas thereof, wherein the second angular turn is caused by diffractive power and has a primary component on the plane; and
wherein a chromatic dispersion of the first angular turn caused by the refractive power of the light control device is substantially compensated by a chromatic dispersion of the second angular turn caused by the diffractive power of the diffractive optical element.

2. The display system of claim 1, wherein (i) the chromatic dispersion is a first chromatic dispersion in a first wavelength, and (ii) a second chromatic dispersion of the first angular turn in a second wavelength caused by the refractive power of the light control device is substantially compensated by the chromatic dispersion of the second angular turn caused by the diffractive power of the diffractive optical element.

3. The display system of claim 2, wherein (i) the first wavelength corresponds to a red wavelength and (ii) the second wavelength corresponds to a blue wavelength.

4. The display system of claim 1, wherein the first angular turn and second angular turn result in a non-zero net angular turn on the plane.

5. The display system of claim 1, wherein a magnitude of the first angular turn is at least ten times that of the second angular turn.

6. The display system of claim 1, wherein (i) the refractive power of the light control device is non-uniform and (ii) the diffractive power of the diffractive optical element is uniform.

7. The display system of claim 1, wherein the refractive power of the light control device and the diffractive power of the diffractive optical element are non-uniform.

8. The display system of claim 1, wherein the diffractive optical element is located downstream of the light control device.

9. The display system of claim 1, wherein the diffractive optical element is located downstream of the replicator and upstream of the light control device.

10. The display system of claim 1, wherein the diffractive optical element is located upstream of the replicator.

11. The display system of claim 1, wherein the refractive power of the light control device and the diffractive power of the diffractive optical element are functions of a position on the output surface.

12. The display system of claim 1, wherein the light control device comprises one of (i) a Fresnel structure, (ii) a part of a Fresnel lens, or (iii) a Fresnel lens.

13. The display system of claim 1, further comprising:
a curved optical component downstream from the light control device, wherein the light control device has an opposite lensing effect of the curved optical component, and wherein the curved optical component comprises one of (i) an optical combiner or (ii) a windscreen of a vehicle.

14. The display system of claim 13, wherein the light control device is arranged to compensate for a curvature of the curved optical component, and wherein the compensation is a function of a position on the output surface.

15. The display system of claim 14, wherein the compensation has negative optical power.

16. The display system of claim 14, wherein the compensation comprises a phase-delay function.

17. The display system of claim 1, wherein the diffractive optical element comprises one or both of (i) a linear grating or (ii) a blazed grating comprising a plurality of gratings.

18. The display system of claim 17, wherein the diffractive optical element comprises a linear blazed grating and the plurality of gratings extends along a first direction, wherein individual gratings of the plurality of gratings comprise a grating pitch that varies along a second direction, and wherein the second direction is perpendicular to the first direction.

19. The display system of claim 17, wherein an individual grating comprises a facet arranged at a surface angle relative to a plane of the diffractive optical element, and wherein the surface angle is such that an associated refraction substantially matches a diffraction angle of an order of refraction.

20. The display system of claim 1, wherein the diffractive optical element is manufactured from a Reactive Mesogen material patterned to impart a phase-delay function.

21. The display system of claim 1, wherein (i) the spatially modulated light comprises a holographic wavefront and (ii) the replicator is arranged to form a plurality of replicas of the holographic wavefront.

22. The display system of claim 1, wherein the spatially modulated light is spatially modulated in accordance with a picture.

23. The display system of claim 1, wherein the spatially modulated light is spatially modulated in accordance with a hologram of a picture, and wherein the hologram is arranged to divide a spatial content of the picture by angle such that angles of the spatially modulated light correspond to spatial coordinates of the picture.

24. The display system of claim 23, further comprising one of (i) a numerical aperture expander arranged to increase a numerical aperture of the spatially modulated light received by the replicator or (ii) a diffuser arranged to increase a numerical aperture of the spatially modulated light received by the replicator.

25. A method of display, wherein the method comprises:
receiving spatially modulated light at a replicator;
replicating the spatially modulated light via the replicator to form a plurality of replicas of the spatially modulated light by waveguiding between a reflective surface and a transmissive-reflective surface, wherein the transmissive-reflective surface forms an output surface for the plurality of replicas of the spatially modulated light;
providing a first angular turn to the plurality of replicas of the spatially modulated light via a light control device located in an optical path of the plurality of replicas of the spatially modulated light downstream from the output surface of the replicator, wherein the first angular turn is caused by refractive power and has a primary component on a plane;
providing a second angular turn to at least one of the spatially modulated light or the plurality of replicas thereof via a diffractive optical element, wherein the second angular turn is caused by diffractive power and has a primary component on the plane; and
substantially compensating a chromatic dispersion of the first angular turn caused by the refractive power of the light control device by a chromatic dispersion of the second angular turn caused by the diffractive power of the diffractive optical element.
